(19) United States
(12) Patent Application Publication
(10) Pub. No.: US 2025/0135404 A1
(43) Pub. Date: May 1, 2025

(54) DIAFILTRATION-NANOFILTRATION-REVERSE OSMOSIS FOR BRINE MANAGEMENT

(71) Applicant: Nanyang Technological University, Singapore (SG)

(72) Inventors: Vinh Hien TRUONG, Singapore (SG); Tzyy Haur CHONG, Singapore (SG)

(21) Appl. No.: 18/904,697

(22) Filed: Oct. 2, 2024

(30) Foreign Application Priority Data
Oct. 30, 2023 (SG) 10202303057T
Jul. 8, 2024 (SG) 10202402003R

(51) Int. Cl. B01D 61/02; C02F 1/44; C02F 103/08

(52) U.S. Cl. CPC B01D 61/029; B01D 61/026; B01D 61/0271; C02F 1/441; C02F 1/442; B01D 2315/16; B01D 2317/022; B01D 2317/025; C02F 2103/08; C02F 2301/046; C02F 2301/08

(57) ABSTRACT

A brine management system and method. The system includes one or more nanofiltration (NF) stages and one or more reverse osmosis (RO) stages. The one or more NF stages are configured to perform a diafiltration process. Each of the one or more NF stages is configured to process a NF feed and produce a NF permeate and a NF retentate. The one or more NF stages cooperatively produces a first brine output of the system. Each of the one or more RO stages is configured to process an RO feed and produce an RO permeate and an RO retentate. At least a part of the RO retentate forms a second brine output of the system. The RO feed to each of the one or more RO stages is exclusively formed from the one or more NF permeate from all of the one or more NF stages.

### CROSS-REFERENCE TO RELATED APPLICATIONS

This application claims the benefit of priority to the Singapore patent application no. 10202303057T, filed Oct. 30, 2023, and the Singapore patent application no. 10202402003R, filed Jul. 8, 2024, the entire contents of which are hereby incorporated by reference in their entireties for all purposes.

### TECHNICAL FIELD

The present disclosure relates generically to the technical field of brine management, and more particularly to an integrated membrane-based system of desalination using diafiltration, nanofiltration, and reverse osmosis.

### BACKGROUND

The desalination of seawater to produce freshwater on a large scale has unfortunately produced by-products that are often directly discharged back to various conveniently located natural bodies of water such as oceans. This can pose a serious threat to the environment and to various ecosystems. As the level of desalination activities around the world escalates to keep up with increasing demand for freshwater for human consumption as well as for many critical industrial processes, there is a pressing need for more sustainable brine management.

### SUMMARY

In one aspect, a system includes one or more nanofiltration (NF) stages configured to perform a diafiltration process and one or more reverse osmosis (RO) stages. Each of the one or more NF stages is configured to process a NF feed and produce a NF permeate and a NF retentate. The one or more NF stages are configured to cooperatively produce a first brine output of the system. Each of the one or more RO stages is configured to process an RO feed and produce an RO permeate and an RO retentate. At least a part of the RO retentate forms a second brine output of the system. The RO feed to each of the one or more RO stages is exclusively formed from the one or more NF permeate from all of the one or more NF stages.

The system may include a NF diluent formed by a portion of the RO permeate, in which the NF diluent is provided to at least one of the one or more NF stages.

The system may be configured with the one or more NF stages being a plurality of the NF stages connected in a series. The respective NF retentate of an upstream one of the plurality of the NF stages is configured to contribute to the respective NF feed of a downstream one of the plurality of the NF stages. The first brine output is provided exclusively by a last of the plurality of the NF stages.

In another aspect, a method of brine management includes using a system to perform a diafiltration process upstream of an RO process, in which the system includes one or more nanofiltration (NF) stages and one or more reverse osmosis (RO) stages. Each of the one or more NF stages is configured to process a NF feed and produce a NF permeate and a NF retentate. The one or more NF stages are configured to cooperatively produce a first brine output of the system. Each of the one or more RO stages is configured to process an RO feed and produce an RO permeate and an RO retentate. At least a part of the RO retentate forms a second brine output of the system. The RO feed to each of the one or more RO stages is exclusively formed from the one or more NF permeate from all of the one or more NF stages.

The method may include forming a NF diluent from a portion of the RO permeate, and providing the NF diluent to at least one of the one or more NF stages.

The method may further include providing a plurality of the NF stages connected in a series, in which the respective NF retentate of an upstream one of the plurality of the NF stages is configured to contribute to the respective NF feed of a downstream one of the plurality of the NF stages. The method may include obtaining the first brine output of the system exclusively from a last of the plurality of the NF stages.

The method may include using the first brine output of the system as a source of multivalent ions in an industrial process instead of directly discharging the first brine output of the system to a natural body of water. The method may include using the second brine output of the system as a source of monovalent ions in an industrial process instead of directly discharging the second brine output of the system to a natural body of water.

### BRIEF DESCRIPTION OF THE DRAWINGS

Various embodiments of the present disclosure will be described with reference to the following figures:

FIG. 1A is a schematic diagram of a system of diafiltration-nanofiltration-reverse osmosis (DiaNF-RO) according to embodiments of the present disclosure;

FIG. 1B is a schematic flow chart illustrating a method of brine management using the system of FIG. 1A;

FIG. 1C is a schematic diagram showing one example of the system of FIG. 1A configured to produce a source for magnesium recovery;

FIG. 2 schematically illustrates an embodiment of an embodiment of the system having two NF stages and one RO stage;

FIG. 3A shows cations rejection rates at an NF stage of the system of FIG. 2;

FIG. 3B shows cations rejection rates at a RO stage of the system of FIG. 2;

FIG. 4 is a flow chart of a numerical method in nDiaNF-RO modeling;

FIG. 5A is a flow chart of an iteration in the NF and RO pressure vessels of the NF stage and the RO stage, respectively;

FIG. 5B is a flow chart showing each iteration of a membrane segment in the pressure vessel;

FIG. 6A is a schematic diagram showing locations of semi-batch experiment steps on a continuous 2DiaNF-RO configuration;

FIG. 6B is a schematic diagram of each cycle in an equivalent semi-batch 2DiaNF-RO configuration;

FIG. 7A shows the absolute percentage error (APE) of semi-batch 2DiaNF-RO experiments at different cycles;

FIG. 7B shows the mean absolute percentage error (MAPE) of 2DiaNF-RO outputs at the 4^{th} cycle;

FIG. 8A shows the experimental results and simulation results for the concentration factor (CF) of cations in each NF stage at the 4^{th} cycle of 2DiaNF-RO;

FIG. 8B shows the experimental results and simulation results for the separation factor (SF) of cations in each NF stage at the 4^{th} cycle of 2DiaNF-RO;

FIG. 8C shows the experimental results and simulation results for the rejection of cations in each NF stage at the 4^{th} cycle of 2DiaNF-RO;

FIG. 8D shows the experimental results and simulation results for the volume ratios in each NF stage at the 4^{th} cycle of 2DiaNF-RO;

FIG. 9A is a partial dependence plot (PDP) of permeate flux on the feed pressure of the S—K model for NF270 membranes;

FIG. 9B is a PDP of Na rejection (R—Na) and Mg rejection (R—Mg) on the feed pressure of the S—K model for NF270 membranes;

FIG. 9C is a PDP of permeate flux on the feed TDS concentration of the S—K model for NF270 membranes;

FIG. 9D is a PDP of Na rejection (R—Na) and Mg rejection (R—Mg) on the feed TDS concentration of the S—K model for NF270 membranes;

FIG. 10A shows changes of 2DiaNF-RO performance indicators IR1 of Na ions and Mg ions, with respect to a unit increase of the operating variable;

FIG. 10B shows changes of 2DiaNF-RO performance indicators CF1 of Na ions and Mg ions, with respect to a unit increase of the operating variable;

FIG. 10C shows changes of 2DiaNF-RO performance indicators SF1 of Mg—Na and net SEC, with respect to a unit increase of the operating variable;

FIG. 10D shows changes of 2DiaNF-RO performance indicators in terms of the total membrane area required with respect to a unit increase of the operating variable

FIG. 11A shows effects of various diluent-RO permeate ratio combinations on 2DiaNF-RO performance indicators of IR1 of Na ions and Mg ions;

FIG. 11B shows effects of various diluent-RO permeate ratio combinations on 2DiaNF-RO performance indicators of CF1 of Na ions and Mg ions;

FIG. 11C shows effects of various diluent-RO permeate ratio combinations on 2DiaNF-RO performance indicators of SF1 of Mg—Na and net SEC;

FIG. 11D shows effects of various diluent-RO permeate ratio combinations on 2DiaNF-RO performance indicators of the total membrane area required;

FIG. 12A shows hypervolume indicators for various nDiaNF-RO configurations over 500 evaluations;

FIG. 12B shows exemplary optimal results for various nDiaNF-RO configurations from the evaluations of FIG. 12A;

FIG. 13A shows exemplary optimization results of nDiaNF-RO with respect to maximized SF1_{Mg-Na} in terms of Na dilution in Br1;

FIG. 13B shows exemplary optimization results of nDiaNF-RO with respect to maximized SF1_{Mg-Na} in terms of Mg concentration in Br1;

FIG. 13C shows exemplary optimization results of nDiaNF-RO with respect to maximized SF1_{Mg-Na} in terms of Na recovery in Br1;

FIG. 13D shows exemplary optimization results of nDiaNF-RO with respect to maximized SF1_{Mg-Na} in terms of Mg recovery in Br1;

FIG. 13E shows exemplary optimization results of nDiaNF-RO with respect to maximized SF1_{Mg-Na} in terms of system water recovery;

FIG. 13F shows exemplary optimization results of nDiaNF-RO with respect to maximized SF1_{Mg-Na} in terms of system net work done rate;

FIG. 14A shows the effects of NF water permeability on 2DiaNF-RO performance outputs;

FIG. 14B shows the effects of NF Na rejection on 2DiaNF-RO performance outputs;

FIG. 14C shows the effects of NF Mg rejection on 2DiaNF-RO performance outputs;

FIG. 15A to FIG. 15C show the NF performance for various configurations in terms of concentration factors, ion recovery, system water recovery, SEC, Brine 1 cost, and separation factor, respectively;

FIG. 16 is a schematic diagram of a 2DiaNF-2RO configuration of the system according to embodiments of the present disclosure;

FIG. 17A and FIG. 17B compares performance indicators for various configurations of the system, including those of the 2DiaNF-2RO configuration;

FIG. 18 is a schematic diagram of the system in a 4DiaNF-RO configuration according to embodiments of the present disclosure;

FIG. 19A to FIG. 19D compare various nDiaNF-RO configurations against a single-pass NF270 pressure vessel (PV) simulation;

FIG. 20A to FIG. 20F show the effect of various membranes on the performance of an embodiment of the DiaNF-RO system;

FIG. 21A and FIG. 21B are respective schematic diagrams of a nDiaNF-RO system and a RO-nDiaNF system forming the basis for a comparative study;

FIG. 22A to FIG. 22D compare performance indicators of the systems of FIG. 21A and FIG. 21B; and

FIG. 23A and FIG. 23D compare operating indicators for the systems of FIG. 21A and FIG. 21B.

### DETAILED DESCRIPTION

The following detailed description is made with reference to the accompanying drawings, showing details and embodiments of the present disclosure for the purposes of illustration and to aid understanding, and not to be limiting. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

As used herein, the term “and/or” includes any and all combinations of one or more of the associated listed items.

The word “exemplary” is used herein to mean “serving as an example, instance, or illustration.” Any embodiment described herein as “exemplary” is not necessarily to be construed as preferred or advantageous over other embodiments.

As used herein, the singular ‘a’ and ‘an’ may be construed as including the plural “one or more” unless apparent from the context to be otherwise.

The terms “about” and “approximately” as applied to a stated numeric value encompasses the exact value and a reasonable variance as will be understood by one of ordinary skill in the art, and the terms “generally” and “substantially” are to be understood in a comparable manner, unless otherwise specified.

Some processes may be described in terms of steps merely to aid understanding and/or for convenient reference. The delineation between one step and another step may be described as such merely for convenient reference in the present disclosure. It will be understood that in actual implementation there may not be a clear division or transition from one step to another subsequent step. There may be a certain amount of overlap among the steps and/or more than one step may occur or be performed concurrently in time, etc.

As used herein, the term “concurrent”, or “concurrently”, is used loosely to refer to two or more occurrences (or events) that at least partially overlap in time. The occurrences may or may not start at the same time instant and/or end at the same time instant.

Terms such as “first” and “second” are used in the description and claims only for the sake of brevity and clarity, and do not necessarily imply a priority or order, unless required by the context.

For the sake of brevity, the terms “freshwater”, “clean water”, “desalinated water”, “drinking water”, “potable water” may be used interchangeably. As used herein, the terms “product water” and “desalinated water” may also refer to “freshwater”, etc., unless the context dictates otherwise.

In the world's open oceans, seawater contains about 35,000 mg/I (milligrams per liter) of total dissolved solids. According to typical standards, potable water should contain no more than 500 mg/I of dissolved solids, of which chloride should not exceed 250 mg/I. It can be appreciated that over 98.5% of the salt in seawater must be removed in order for the treated seawater to meet the quality standards for potable water or freshwater.

One of the inherent problems of conventional desalination is the production of highly concentrated brine as a by-product. For example, with a recovery rate from about 35% to about 50%, a conventional seawater reverse osmosis (SWRO) desalination process can generate as much as one unit of brine at doubled seawater salinity for every unit of freshwater produced. Dumping high salinity by-products back into the ocean is no longer deemed viable in light of the detrimental environmental impact to delicate marine and coastal ecosystems. The alternative provided by conventional brine management is highly energy intensive. Conventional brine management seeks to maximize water recovery and to reduce the volume of the by-product brine, ideally to achieve near-zero or zero liquid discharge (ZLD). This involves large energy consumption owing to the mechanisms of conventional processes such as electrodialysis, multi-effect distillation, etc. Handling high salinity by-product brine also means that the water treatment facilities is more prone to fouling.

### Diafiltration-Nanofiltration-Reverse Osmosis (DiaNF-RO)

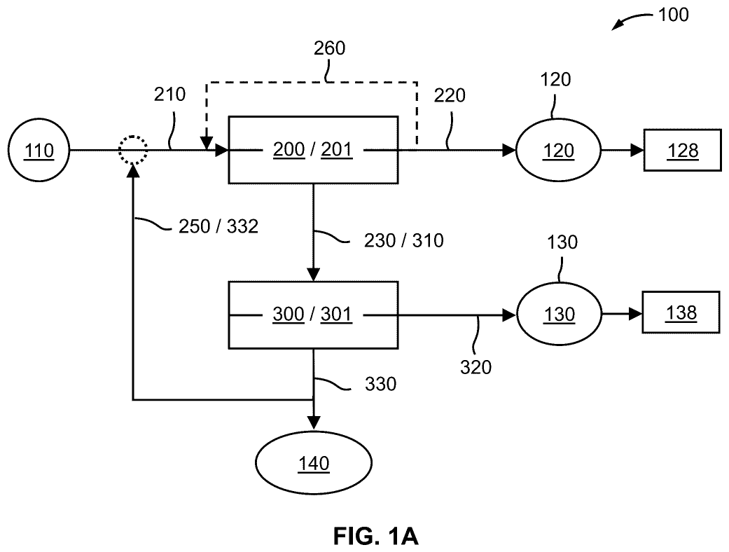

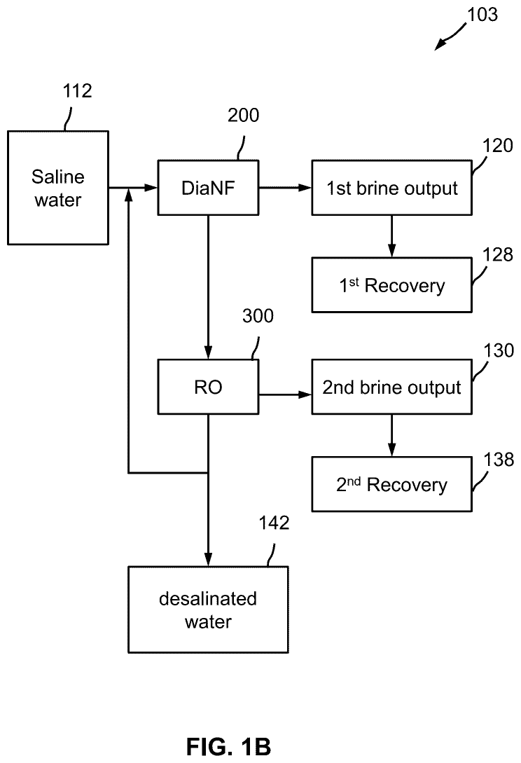

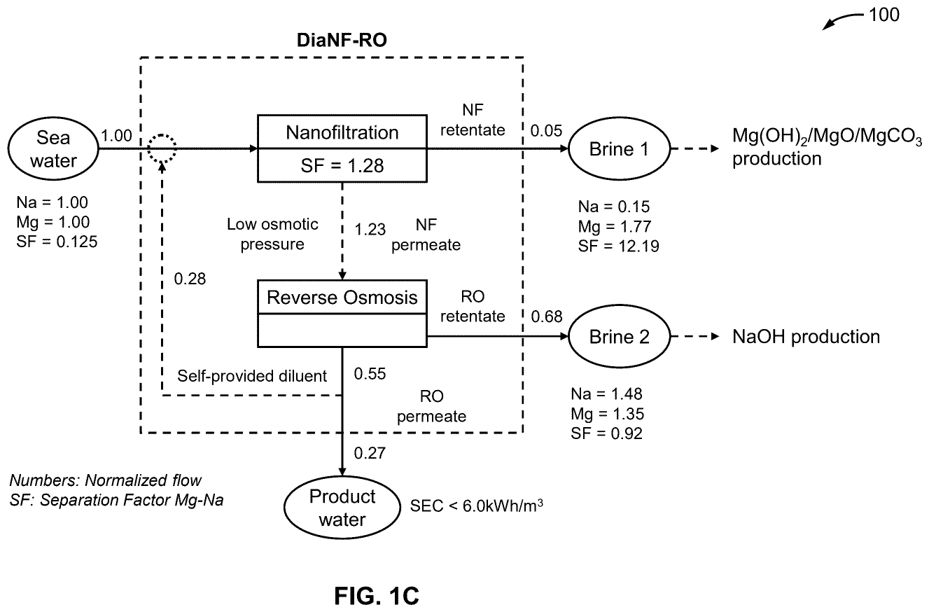

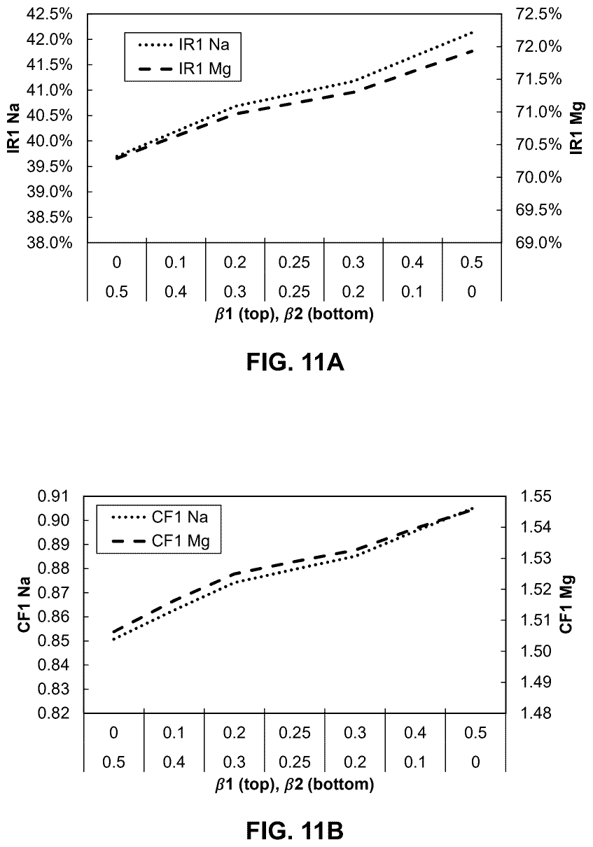

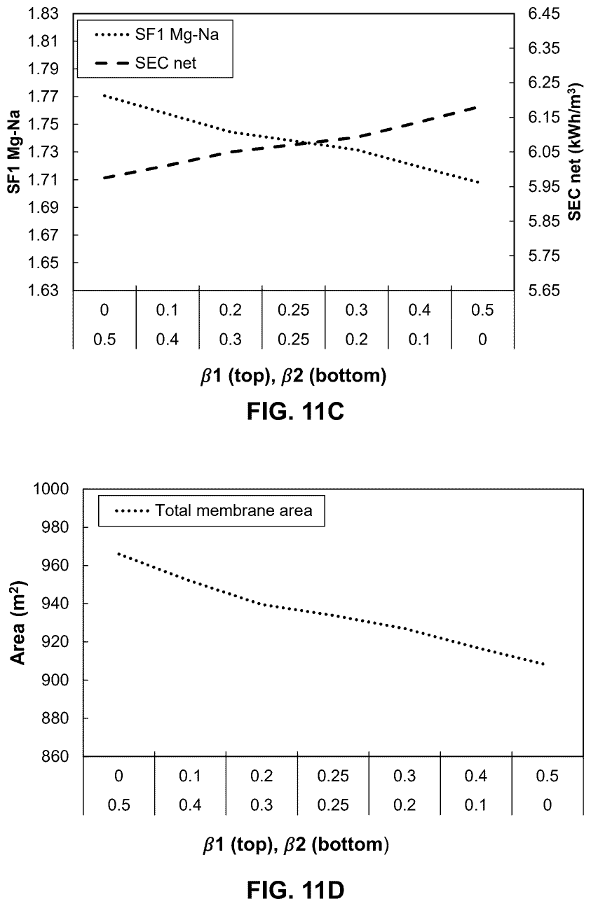

FIG. 1A schematically illustrates a system 100 configured to perform a method of brine management, referred to herein as diafiltration-nanofiltration-reverse osmosis (DiaNF-RO) for the sake of brevity. FIG. 11B schematically illustrates a brine management method 103 enabled by the system 100.

The system 100 includes a diafiltration process 200 and a reverse osmosis (RO) process 300 integrated to produce a first brine output 120 (also referred to herein as “Brine 1” or “Br1”), a second brine output 130 (also referred to herein as “Brine 2” or “Br2”), and a desalinated water output 140 (also referred to herein as “product water” or “desalinated water”, etc.), based on a system input 110 configured to deliver a supply of saline water to the diafiltration process 200.

The diafiltration process 200 (also referred to interchangeably as the NF process or NF section) may include one NF stage 201 or a plurality of nanofiltration (NF) stages 201 serially connected to one another. The RO process 300 (also referred to interchangeably as the RO section) may include one RO stage 301 or a plurality of RO stages 301 serially connected to one another. Each of the NF stages 201 or the RO stages 301 (collectively referred to as a membrane stage) includes a membrane. For example, each NF stage 201 may include an NF membrane and be configured to perform a diafiltration process 200. Each NF stage 201 may be configured to process a NF feed 210 and produce a NF permeate 230 and a NF retentate 220. For example, each RO stage 301 may include a RO membrane and be configured to perform an RO process 300. Each RO stage 301 may be configured to process an RO feed 310 and produce an RO permeate 330 and an RO retentate 320.

In the examples where the NF process 200 is performed by a plurality of NF stages 201, all the NF stages 201 are connected in series. The NF stages 201 are connected with one another to form one series of NF stages (also referred to herein as the “NF series” for the sake of clarity). The system input 110 draws from a source of saline water and feeds solely into the first NF stage in the series. The NF retentate 220 of the last NF stage in the series provides the first brine output 120. In the NF series, the NF retentate of an upstream NF stage forms the NF feed of a downstream NF stage, in which the downstream NF stage is immediately downstream of the upstream NF stage in the NF series. In examples where the one or more NF stages is a plurality of the NF stages connected in a series, the respective NF retentate of an upstream one of the plurality of the NF stages contributes to the respective NF feed of a downstream one of the plurality of the NF stages. The first brine output 120 is provided exclusively by a last of the plurality of the NF stages 201.

The NF permeate 230 of each of the NF stages 201 collectively forms the RO feed 310 to the RO process 300. The RO feed 310 to each of the one or more RO stages 301 is exclusively formed from the one or more NF permeate 230 from all of the one or more NF stages 201.

In the examples where the RO process is performed by a plurality of RO stages 301, all the RO stages 301 are connected in series. The RO stages 301 are connected with one another to form one series of RO stages (also referred to herein as the “RO series” for the sake of clarity). The NF permeate 230 is fed to the first RO stage in the series. The RO retentate 320 of the last RO stage in the series provides the second brine output 130. In the RO series, the RO retentate of an upstream RO stage forms the RO feed of a downstream RO stage, in which the downstream RO stage is immediately downstream of the upstream RO stage in the RO series. The RO permeate 330 from one or more of the RO stages 301 may be directed to form the desalinated water output 140 of the system 100. A part of the RO permeate from one or more of the RO stages 301 may be directed to the NF process for use as an NF diluent 250 for one or more NF stages 201.

The RO process 300 may be described as being downstream of the NF process 200 in that the RO feed 310 is wholly provided by the NF permeate 230. The system input 110, e.g., seawater, does not directly contribute to the RO feed 310 of any of the one or more RO stages 301.

The NF diluent 230 is formed by a portion 332 of the RO permeate 330. The NF diluent 250 is provided to at least one of the one or more NF stages 201 in the NF series.

In some embodiments where a first selected one or more of the plurality of the NF stages 201 are configured to operate without the NF diluent, and wherein a second selected one or more of the plurality of the NF stages 201 are configured to operate with the NF diluent, all of the first selected one or more of the plurality of the NF stages are upstream of all of the second selected one or more of the plurality of the NF stages.

In some embodiments, at least one of the one or more NF stages 201 is configured to recycle 260 the respective NF retentate through the at least one of the one or more NF stages 201.

In some embodiments, one or more RO stages 301 are configured to recycle the RO retentate through the one or more RO stages 301.

The first brine output of the system serves as a viable source of multivalent ions from which the multivalent ions are extractable by a first recovery process. The second brine output of the system may further serve as a viable source of monovalent ions from which the monovalent ions can be extracted by a second recovery process.

The system is configured to have the system input 110 feeding exclusively into a first of the one or more NF stages 201, in which the first brine output 120 and the second brine output 130 are formed from different ion fractionated streams of the system input 110. The system is configured to provide a first brine output 120 that is characterized by a higher content of multivalent ions in comparison to the second brine output.

In examples where the system input 110 is configured to deliver a supply of saline water to the first of the one or more NF stages 201, the saline water including the multivalent ions and monovalent ions, and wherein the RO permeate 330 contributes to a desalinated water output 140 of the system 100.

A composition of the first brine output 120 is configured as a source of the multivalent ions from which at least a portion of the multivalent ions are extractable. For example, the first brine output 120 may be processed by a first recovery process 128 to obtain useful products instead of being directly discharged into the environment. Examples of the multivalent ions include but are not limited to magnesium ions, calcium ions, sulfate ions, carbonate ions, or a combination of any two or more thereof.

A composition of the second brine output 130 may include a lower concentration of magnesium the multivalent ions in comparison with the first brine output. A composition of the second brine output is configured as a source of monovalent ions from which at least a portion of the monovalent ions is extractable. Examples of the monovalent ions include but are not limited to sodium ions, lithium ions, chlorine ions, potassium ions, hydrogen carbonate ions, or a combination of any two or more thereof.

In some embodiments, a ratio of the NF diluent provided to any one of the plurality of the NF stages to the RO permeate (β) is in a range from about 0.30 to about 0.70. The ratio β may be a value selected from the range from 0.30 to 0.70.

In some embodiments, the plurality of the NF stages 201 is formed by an upstream NF stage and a downstream NF stage, and wherein a ratio of the NF diluent provided to the downstream NF stage to the RO permeate is 0.5 or about 0.5.

The composition of the first brine output may be configurable. The system may be configured such that, in operation, the composition of the first brine output is responsive to a change in any one or more of the following: (i) a ratio (β) of the NF diluent 250 provided to any one of the plurality of the NF stages 201 to the RO permeate 330; and (ii) a number of the one or more NF stages 201 operating in the operation of the system 100; (iii) an NF pressure of the NF feed 210; and (iv) a rate of flow of the NF feed 210.

The composition of the first brine output 120 may be dependent on one or more membrane properties of the NF membrane. Examples of such membrane properties include the active area or the NF membrane area. Examples of such membrane properties include the permeability of selected multivalent ions, etc.

In some embodiments, the system 100 is configured with two RO stages 301, e.g., a first RO stage and a second RO stage. The system 100 may be configured with the one or more NF permeate 230 being wholly provided to the first RO stage as the RO feed 310 of the first RO stage, and in which the second brine output 130 is formed exclusively from the RO retentate 320 of the second RO stage, and in which the RO retentate of the first RO stage is wholly provided to the second RO stage as the RO feed of the second RO stage.

The following describes simulation and experimental results demonstrating the viability of the proposed brine management system and method, including taking into account the specific energy consumption and system efficiencies.

### 2DiaNF-RO

In the schematic diagram of FIG. 1C, the system 100 is shown in terms of a normalized flow calculated on the assumption that the Mg—Na separation factor of the NF membranes is 1.28, for the purpose of illustration to aid understanding and not to be limiting.

In this example, a diafiltration process is applied at the NF stage (forming DiaNF) to enhance the divalent/monovalent ions, i.e., Mg/Na fractionation performance of the NF, while the RO is incorporated to produce desalinated water as well as diluent required by the DiaNF.

In this embodiment, the DiaNF-RO system or the system 100 may include at least two NF stages to concentrate and separate divalent ions from monovalent ions in seawater before the RO stage for desalination. The NF stages are connected in series. The NF permeates are combined and become the RO feed to the RO stage. The RO stage provides both product water and NF diluent for the diafiltration process in the NF stages. The amount of NF diluent at each NF stage may be controlled independently as a fraction of RO permeate via the parameter β. Retentate recycling (Rec) is used to mitigate scaling by regulating the safety factor (retentate-permeate flow ratio) to be more than one when necessary. One or more energy recovery device (ERD) may be employed at the retentate stream (e.g., NF retentate and/or RO retentate) of each membrane stage (e.g., NF stage and/or RO stage) to recover pressure energy and reduce the pumping energy required by the booster pump (BP) in the NF stages and the high-pressure pump (HPP) in the RO stage(s). The DiaNF-RO system produces three final streams: (i) Brine 1 (Br1), the retentate of the last NF stage, which is rich in divalent ions; (ii) Brine 2 (Br2), the retentate of RO stage, which is rich in monovalent ions; and (iii) product water (PW), the net RO permeate, which contains clean water.

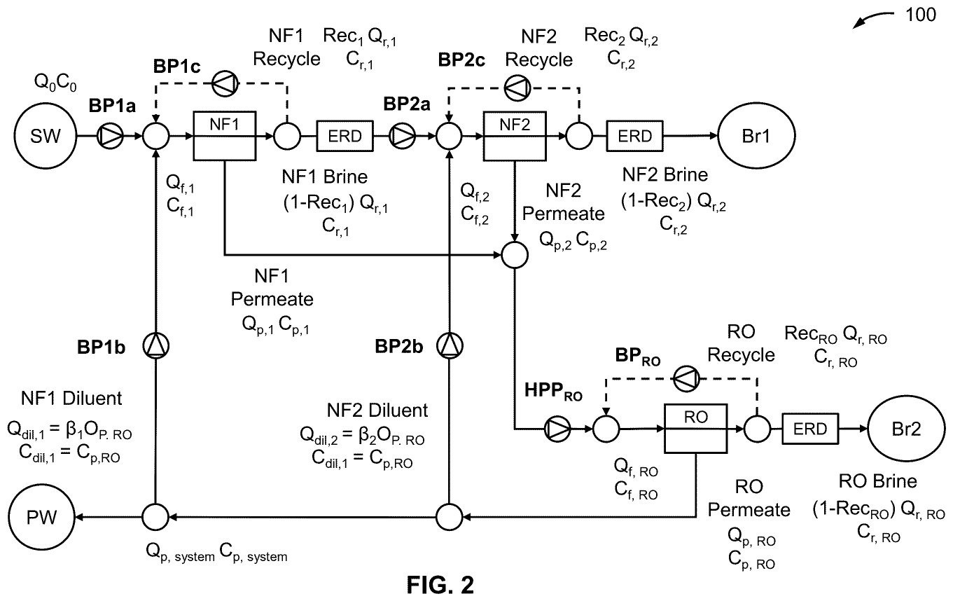

FIG. 2 depicts a schematic diagram of 2DiaNF-RO configuration (as an example of the system 100) for modelling, solving procedures and sensitivity analysis, to aid understanding. FIG. 2 additionally shows the system labelled with flow rate relationships to aid understanding. One skilled in the art would understand that results based on the 2DiaNF-RO configuration can be extended to all DiaNF-RO configurations with different numbers of NF and RO stages, in accordance with embodiments of the present disclosure.

### Numerical Modelling

### NF and RO Pressure Vessels

The Spiegler-Kedem (S-K) model was utilized to simulate the flux and rejection performances of both the NF and RO membranes. The S—K model does not require specific membrane characteristics, such as pore radius or membrane charge, and facilitates a more flexible membrane selection and easier simulation of multi-ionic solution.

In the S—K model, irreversible thermodynamics assumes the membrane as a black box without considering any specific transport mechanism such as steric hindrance and electrostatic repulsion. The S—K model may be used to describe the water and ion transport by using the water and solute fluxes (Equations (1) and (2)) and the following empirical parameters: water permeability (Lₚ), solute permeability (Pₛ), and reflection coefficient (σ).

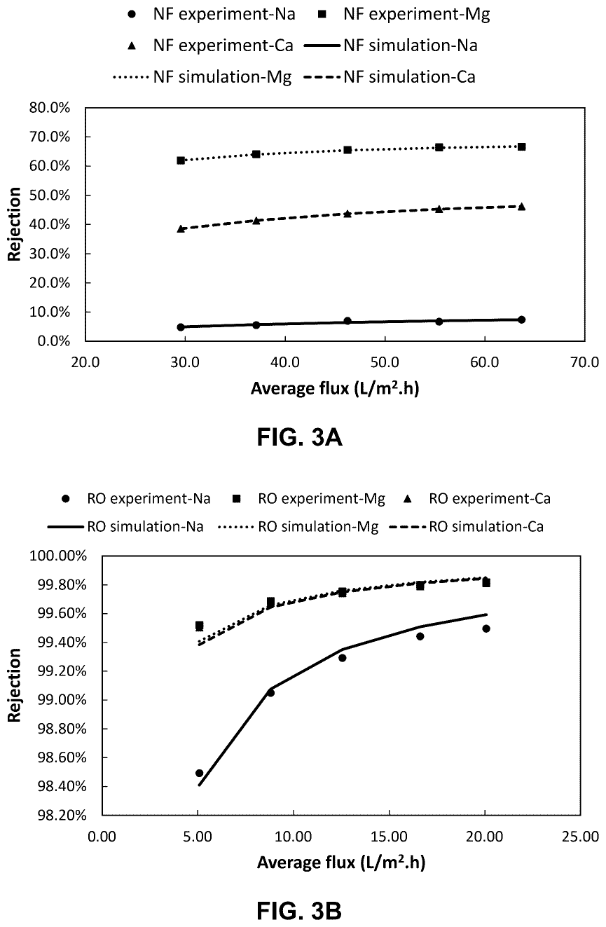

The present example is based on a NF270 membrane and a SW30HR membrane (both available from Dow) as the NF and RO membranes respectively. It would be understood from the following description that other membranes may be selected for use in the system. For the NF270 membrane, the coefficients in the S—K model, which are Lₚ, Pₛ, and σ, were empirically obtained in a two-step procedure. At each feed concentration, the values of the coefficients were determined by varying the pressure from 6 to 14 bar. The water permeability coefficient (Lₚ) was obtained from the slope of the linear regression between the permeate flux and the pressure (Equation (1)). The solute permeability (Pₛ) and reflection coefficient (σ) were found simultaneously by minimizing the sum-of-squared-errors (SSE) when fitting the rejection with the permeate flux according to the respective rejection model (Equation (3) and (4)). As an illustration, the fitting curves of relevant cations at 42 g/L feed concentration are shown in FIG. 3A.

After repeating the above step for the feed concentration from 32 to 61 g/L, linear regression was applied to find the correlation between the model coefficients with the feed concentration (TDS) in g/L. This is so that in future simulations, the obtained coefficients could reflect the NF performance more accurately when subjected to different feed concentration conditions. For the water permeability coefficient, the correlation was Lₚ=−0.0231*TDS+5.6502, with β₂=0.7759. For the solute permeability and reflection coefficient, their specific correlations for each ion are shown in Table 1.

TABLE 1
Correlations of Pₛ and σ of each
ion with TDS feed concentration for NF270

| Ions | Pₛ correlation | σ correlation |
|---|---|---|
| Na | Pₛ = 0.2026*TDS + 24.88 | σ = −0.0004*TDS + 0.0923 |
| | R2 = 0.3703 | R2 = 0.1264 |
| Mg | Pₛ = 0.0601*TDS + 3.967 | σ = 0.0030*TDS + 0.5601 |
| | R2 = 0.7788 | R2 = 0.8874 |
| Ca | Pₛ = 0.0797*TDS + 11.277 | σ = 0.0028*TDS + 0.3821 |
| | R2 = 0.4169 | R2 = 0.7861 |
| Cl | Pₛ = 0.2925*TDS + 12.06 | σ = 0.0005*TDS + 0.1559 |
| | R2 = 0.9770 | R2 = 0.9595 |
| SO₄ | Pₛ = 0.0104*TDS + 0.6574 | σ = 0.0002*TDS + 0.9105 |
| | R2 = 0.0374 | R2 = 0.0796 |

For the RO membrane (SW30HR), the empirical fitting process for Lₚ and Pₛ in the solution diffusion (S-D) model (i.e., S—K model where σ=1) was similarly conducted, in the pressure range from 35 to 50 bar. In this case, the Lₚ was obtained from the linear regression of deionized water flux, rather than from the salt flux as in the NF case. Hence, the value of Lₚ was 0.9503 with β₂=0.9998. The least-squared-fitting of Pₛ for cations at TDS=32 g/L is also shown in FIG. 3B as an illustration. The process was repeated for the feed concentration from 32 to 37 g/L, which is the typical range for seawater. Owing to the small variation of the Pₛ in the given feed range, average values were used instead of linear regression correlations. The Pₛ values for each ion are shown in Table 2.

TABLE 2
Average values of Pₛ of each ion for SW30HR

| Ions | Average Pₛ (L/m² · h) | Standard deviation (L/m² · h) |
|---|---|---|
| Na | 0.0919 | 0.0138 |
| Mg | 0.0338 | 0.0051 |
| Ca | 0.0354 | 0.0055 |
| Cl | 0.0783 | 0.0168 |
| SO4 | 0.0226 | 0.0069 |

Following the empirical fitting of the NF and RO membranes, the volumetric flux equation and solute flux equations can be solved.

Volumetric flux:

$${J}_{v} = {L}_{p} ( Δ P - σ Δ {π}_{m} ) \qquad ( 1 )$$

where Jv is the total volumetric flux of water (L/m²·h); Lp is the water permeability coefficient (L/m²·h·bar); σ is the reflection coefficient; ΔP is the hydraulic pressure difference (bar); and Δπₘ is the osmotic pressure difference (bar).

The solute flux equation:

$${J}_{s} = {P}_{s} Δ {C}_{s} + ( 1 - σ ) {J}_{v} \overline{{C}_{s}} \qquad ( 2 )$$

where Jₛ is the solute flux (kg/m²·h); Pₛ is the solute permeability coefficient (L/m²·h); ΔCₛ=Cₘ−Cₚ is the difference between solute concentration at the membrane surface Cₘ and in the permeate Cₚ (mg/L); and

$${\overline{C}}_{s} = \frac{Δ C}{Δln {C}_{s}} = \frac{{C}_{m} - {C}_{p}}{ln ( {C}_{m} / {C}_{p} )}$$

is the log-average of the solute concentration(mg/L).

By solving the 2 flux equations, the intrinsic rejections, Rᵢₙₜ, of NF and RO can be found as a function of the volumetric flux:

$${R}_{i n t , NF} = 1 - \frac{{C}_{p}}{{C}_{m}} = \frac{( 1 - F ) σ}{1 - σ F} with F = {e}^{- {J}_{v} ( \frac{1 - σ}{{P}_{s}} )} \qquad ( 3 )$$

$${R}_{i n t , RO} = 1 - \frac{{C}_{p}}{{C}_{m}} = {( 1 + \frac{{P}_{s}}{{J}_{v}} )}^{- 1} \qquad ( 4 )$$

where F is the flow parameter.

Next, the Concentration Polarization (CP) which refers to the concentration gradient formed in the fluid adjacent to the membrane surface is computed. CP is modelled based on the film theory, where the constants in Sherwood number are empirically obtained for the spacer-filled channels.

$$CP = \frac{{C}_{m} - {C}_{p}}{{C}_{b} - {C}_{p}} = exp ( \frac{{J}_{v}}{k} ) \qquad ( 5 )$$

$$k = \frac{D * Sh}{{d}_{h}} \qquad ( 6 )$$

$$Sh = 0.065 {( Re )}^{0.875} {( Sc )}^{0.25} \qquad ( 7 )$$

where C_{b} is the solute concentration at the bulk solution (mg/L); k is the mass transfer coefficient (m/s); D is the solute diffusivity (m²/s); dh is the hydraulic diameter of the flow channel (m); Sh is the Sherwood number; Re is the Reynolds number; and Sc is the Schmidt number.

The spatial variations of the local fluid properties in the pressure vessel (PV) are also considered to describe the drop in velocity, concentration, and pressure along the channel. This allows more accurate prediction of water and solute flux in the membrane PV. The crossflow velocity (uₓ), solute concentration (cₓ), and trans-membrane hydraulic pressure (Δpₓ) at any spatial point can be expressed by:

$${u}_{x} = {u}_{0} - \frac{2}{{ε}_{sp}} {\int }_{x = 0}^{x = L} \frac{{J}_{v}}{H} dx \qquad ( 8 )$$

$${c}_{x} = \frac{1}{{u}_{x}} ( {u}_{0} {c}_{0} - \frac{2}{{ε}_{sp}} {\int }_{x = 0}^{x = L} \frac{{J}_{s}}{H} dx ) \qquad ( 9 )$$

$$Δ {p}_{x} = Δ {p}_{0} - \frac{12 K μ}{{H}^{2}} {\int }_{x = 0}^{x = L} {u}_{x} dx \qquad ( 10 )$$

where u₀, c₀, and Δp₀ are the cross-flow velocity (m/s), the solute concentration (mg/L), and the trans-membrane hydraulic pressure (Pa) at the inlet (x=0), respectively; H and L are the flow channel height and length (m), respectively; εₛₚ is the effective porosity of the channel; y is the dynamic viscosity of the fluid (Pa·s); and K is the friction coefficient of the channel wall and spacer.

Finally, the average permeate flow (Q_{p,}_{^{PV}}) and permeate ion concentration (C_{p,}_{^{PV}}) of a PV:

$${Q}_{p , PV} = {\int }_{x = 0}^{x = TL} {J}_{v} Wdx \qquad ( 11 )$$

$${C}_{p , PV} = \frac{{\int }_{x = 0}^{x = TL} {J}_{v} {C}_{p} Wdx}{{Q}_{p , PV}} \qquad ( 12 )$$

where TL is the total length of the all the membrane elements in the pressure vessel (m); and W is the width of the flow channel (m).

### Mixing Points

At the mixing points in FIG. 1C, mixing is assumed to be complete and the hydraulic residence time within each stage and pipeline is negligible. As such, the mass balance equations for the 2DiaNF-RO process are as follows:

$$\frac{{dV}_{f , 1}}{dt} = {Q}_{0} + ( 1 - {Rec}_{1} ) {Q}_{r , 1} + {β}_{1} {Q}_{p , RO} \qquad ( 13 )$$

$$\frac{{dC}_{f , 1}}{dt} = \frac{{Q}_{0} {C}_{0} + ( 1 - {Rec}_{1} ) {Q}_{r , 1} {C}_{r , 1} + {β}_{1} {Q}_{p , RO} {C}_{p , RO}}{{V}_{f , 1}} - \frac{{C}_{f , 1}}{{V}_{f , 1}} \frac{{dV}_{f , 1}}{dt} \qquad ( 14 )$$

$$\frac{{dV}_{f , 2}}{dt} = {Q}_{r , 1} + ( 1 - {Rec}_{2} ) {Q}_{r , 2} + {β}_{2} {Q}_{p , RO} \qquad ( 15 )$$

$$\frac{{dC}_{f , 2}}{dt} = \frac{{Q}_{r , 2} {C}_{r , 2} + ( 1 - {Rec}_{2} ) {Q}_{r , 2} {C}_{r , 2} + {β}_{2} {Q}_{p , RO} {C}_{p , RO}}{{V}_{f , 2}} - \frac{{C}_{f , 2}}{{V}_{f , 2}} \frac{{dV}_{f , 2}}{dt} \qquad ( 16 )$$

$$\frac{{dV}_{f , RO}}{dt} = {Q}_{p , 1} + {Q}_{p , 2} + ( 1 - {Rec}_{RO} ) {Q}_{r , RO} \qquad ( 17 )$$

$$\frac{{dC}_{f , RO}}{dt} = \frac{{Q}_{p , 1} {C}_{p , 1} + {Q}_{p , 2} {C}_{p , 2} + ( 1 - {Rec}_{RO} ) {Q}_{r , RO} {C}_{r , RO}}{{V}_{f , RO}} - \frac{{C}_{f , RO}}{{V}_{f , RO}} \frac{{dV}_{f , RO}}{dt} \qquad ( 18 )$$

where V, Q, C are the volume (m³), volumetric flow rate (m³/d), and ion concentration (mg/L) of the fluid at different stages, respectively; and Rec is the retentate recycle ratio of each stage (dimensionless).

### System Performance

The system performance of the proposed system 100 (the DiaNF-RO performance) was studied. Relevant output indicators are defined. For ion fractionation, the concentration factor (CF) evaluates the degree of concentration and dilution of an ion with respect to the initial concentration, while the separation factor (SF) shows the selectivity between 2 ions via their concentration factors. The CF of ion A and SF between ions A and B at a given membrane stage are:

$${CF}_{A} = \frac{{C}_{A , final}}{{C}_{A , 0}} \qquad ( 19 )$$

$${SF}_{A / B} = \frac{{C}_{A , final} / {C}_{A , 0}}{{C}_{B , final} / {C}_{B , 0}} \qquad ( 20 )$$

where C_{A,final}, C_{B,final} are the concentrations of ions A and B in the final retentate or permeate streams (mg/L), respectively; C_{A,0}, C_{B,0} are the concentrations of ions A and B in the initial feed (mg/L), respectively.

In terms of desalination efficiency, the system water recovery (Yₛ) shows the percentage of clean water that can be collected from the process from a given feed flow rate, while the net specific energy consumption (SECₙₑₜ) indicates the net work done rate required to produce a unit volume of clean water, after considering the energy saving from ERDs. Yₛ and SECₙₑₜ can be calculated by the equations below:

$${Y}_{s} = \frac{{Q}_{p , system}}{{Q}_{f , 0}} \qquad ( 21 )$$

$$S E {C}_{net} = \frac{{\dot{W}}_{required} - {\dot{W}}_{recovered}}{{Q}_{p , system}} = \frac{\sum {P}_{pump} {Q}_{pump} - {η}_{ERD} \sum {P}_{ERD} {Q}_{ERD}}{{η}_{pump} {Q}_{p , system}} \qquad ( 22 )$$

where \dot{W} is the work done rate of the pump or ERD (kWh/d); Pₚᵤₘₚ and P_{ERD} are the pressures of the flow going through the pump and ERD (bar), respectively; ηₚᵤₘₚ and η_{ERD} are the efficiencies of pump and ERD, respectively; Qₚᵤₘₚ and Q_{ERD} are the flow rates going through the pump and ERD (m³/d), respectively; and Q_{p,system} is the system permeate flow rate (m³/d).

To ensure that there is sufficient clean permeate flow for both dilution and desalination, the RO water recovery was fixed. This led to the variation of RO membrane area per stage, which is obtained from the equation below:

$${A}_{RO} = \frac{{Q}_{p , RO}}{{J}_{p , RO}} \qquad ( 23 )$$

where A_{RO} is the required RO area per stage (m²); Q_{p,}_{^{RO}} is the average RO permeate flow (m³/d) from Y_{RO}; and J_{p,}_{^{RO}} is the average RO permeate flux (L/m²·h).

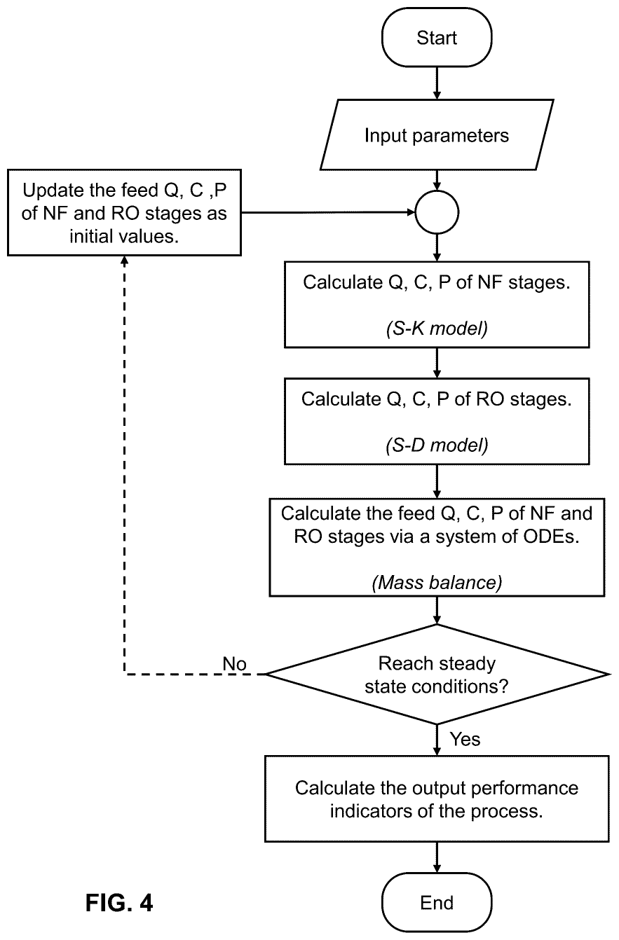

FIG. 4 summarizes the methodology used to numerically solve through the governing equations of the 2DiaNF-RO process with Python and its associated Numpy and Scipy libraries.

In Step (a), the input parameters are specified. The input parameters consist of the membrane PV properties in Table 3, empirically derived S—K coefficients in Table 1 and Table 2, feed water characteristics and operating conditions in Table 4.

TABLE 3
Properties of the NF and RO PV simulations

| | NF | RO |
|---|---|---|
| Configurations | Spiral wound | Spiral wound |
| | (NF270) | (SW30HR) |
| Membrane area/element | 37.2 | 40.9 |
| (m²) | | |
| Number of | 31 | 31 |
| leaves/elements | | |
| Leaf length, L (m) | 0.915 | 0.915 |
| Spacer thickness, H (m) | 8.64 × 10⁻⁴ | 7.11 × 10⁻⁴ |
| Spacer porosity, εₛₚ | 0.8 | 0.8 |
| Friction coefficient due | 10 | 7 |
| to spacer, K | | |
| Dynamic viscosity of | 1.0978 × 10⁻³ | 1.0978 × 10⁻³ |
| water, μ (Pa · s) | | |
| Solute diffusivity, D (10⁻⁹ | 1.51 | 1.51 |
| m²/s) | | |
| Transport model | Spiegler-Kedem | Solution diffusion |
| | 0 < σ < 1 | σ = 1 |

TABLE 4
Constant operating conditions of the DiaNF-RO simulations

| Seawater feed | Na = 11122, Mg = 1394, Ca = 382, SO4 = 2136, |
|---|---|
| concentration (mg/L) | Cl = 20300 (TDS = 35334) |
| Feed flow (m³/d) | 500 |
| Simulation time (s) | 20 |
| Pump efficiency | 0.85 |
| ERD efficiency | 0.90 |

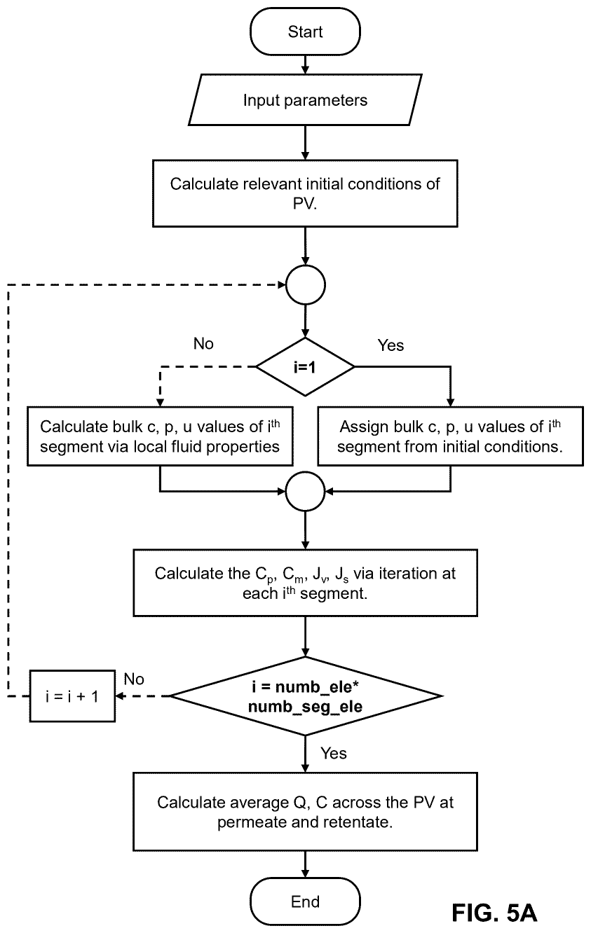

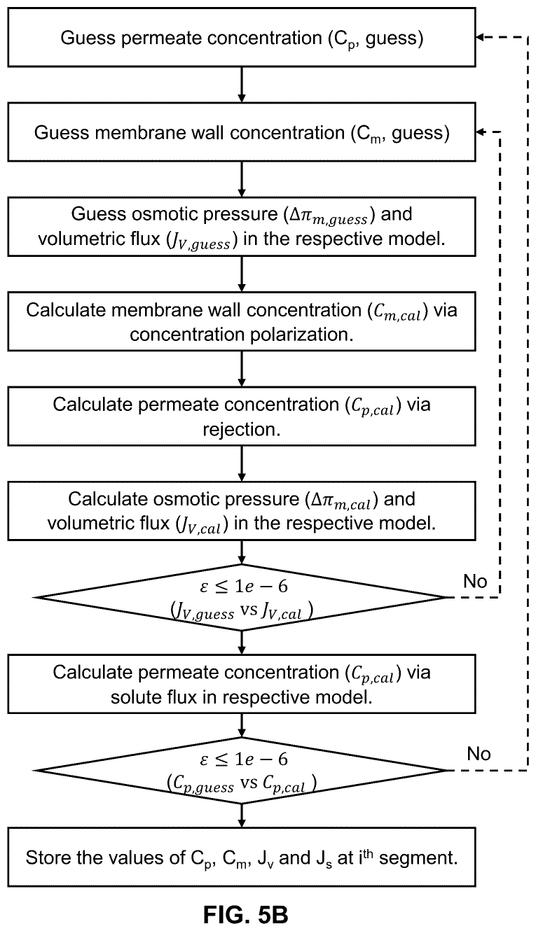

In Step (b), the spiral-wound pressure vessels (PV) of a NE or RO membrane was simulated based on the algorithm that discretized each membrane into different small i^{th} segments and applied the relevant transport models (S—K for NE and S-D for RO) on each individual segment. Equations (1)-(12) are iteratively solved until the error between the guessed and calculated values of the permeate flux and permeate ion concentration are below the tolerance error value of 1×10⁻⁶. The flow chart of this procedure is shown in FIG. 5B.

The procedure was then repeated for every segment of each membrane element, and for all elements, shown in FIG. 5A. At each segment, the concentration polarization effect was considered, but fouling was assumed to be negligible due to the relatively short simulation time and moderate feed concentration. Between each segment, the effects of pressure drop, velocity drop, and concentration drop were considered via the friction coefficient K. Finally, the output flows and concentrations were calculated by taking the average of all the values from every segment. That is, the results from FIG. 5B were used to calculate for all segments and to find the average Q and C across the pressure vessel.

In Step (c), the feed flow and concentration values of NF1, NF2, and RO stages are then calculated by solving ordinary differential equations (ODEs) (13)-(18). Step (b) and Step (c) are repeated until steady state conditions are reached.

In Step (d), the output performance indicators of 2DiaNF-RO at steady state (i.e., CF_{Na}, CF_{Mg}, SF_{Mg/Na}, Yₛ, SECₙₑₜ, and A_{RO}) are calculated based on equations (19)-(23). Mg and Na are selected as the representatives for the divalent and monovalent ions, respectively, because they have high concentrations in seawater and can be economically extracted.

### Experimental Set-Up

The lab-scaled batch experimental set-up consisted of a crossflow flat-sheet membrane filtration unit with effective membrane area of 0.0214 m², 10 L feed tank, high pressure pump, pressure and flow regulators, pressure gauges, flow meters, conductivity meters, and weighing balance. The trans-membrane pressure (TMP) was varied in the range of 6-14 bar by fixing the pump rate and varying the retentate pressure, and crossflow velocity were kept constant at 0.4 L/min. In recycling mode, retentate and permeate were recirculated to the feed tank, while in concentration mode, permeate was withdrawn to another tank. The permeate and retentate volumes were measured by the weighing balance, from which the water recovery and permeate flux were determined. The membranes tested were the NF270 and SW30HR from Dow FilmTec, selected for their high divalent ion rejection and seawater application suitability. Feed/retentate and permeate were sampled for cation and anion analyses by Inductively Coupled Plasma Optical Emission Spectrometry (ICP-OES, Perkin Elmer) Ion Chromatography (IC, Thermo Fisher Scientific), respectively. For ICP-OES, the calibration standard for Na⁺ was from 9.375 mg/L to 300 mg/L, while that for Mg²⁺ and Ca²⁺ was from 0.625 mg/L to 20 mg/L. Given the cation concentration range in seawater and NF/RO brine, the samples were diluted by 100 times for ICP. Meanwhile, the IC calibration standard for Cl⁻ and SO₄²⁻ was from 0.05 mg/L to 50 mg/L, which corresponded to 1000 times dilution for the samples.

To facilitate the model validation of 2DiaNF-RO, an equivalent semi-batch experiment of the continuous 2DiaNF-RO process was proposed. For the testing, the continuous 2DiaNF-RO process in this case was assumed to operate without any retentate recycling (i.e., Rec=0) and with dilution only in the last NF2 stages (i.e., β₁=0, β₂=3) to ensure high performance.

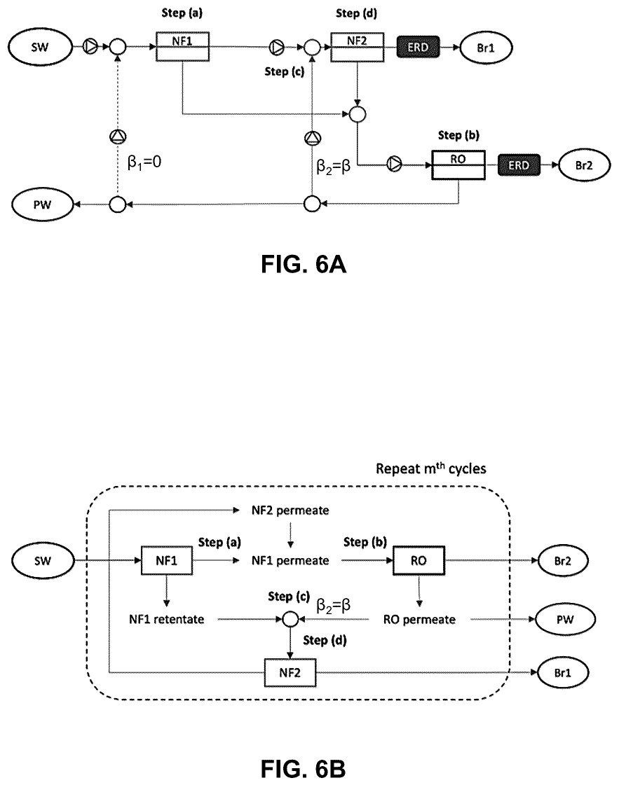

Table 5 summarizes the test conditions of the semi-batch experiments and FIG. 6A and FIG. 6B depict each cycle of the semi-batch design which consisted of four steps that are matched with the continuous process.

Experimental Step (a) was the batch NF1 concentration of the seawater feed to a fixed recovery Y₁.

Experimental Step (b) was the batch RO concentration of the NF1 permeate from the current cycle with the NF2 permeate from the previous cycle, if any, to a fixed recovery Y_{RO}.

Experimental Step (c) involved mixing the NF1 retentate from the current cycle with some β-portion of the newly formed RO permeate.

Experimental Step (d) was the batch NF2 concentration of the solution in step © to a fixed recovery Y₂.

The cycle was then repeated for m number of times to ensure that the final volume and concentration of the semi-batch experiment were equivalent to those of the continuous design at steady state.

### Proof of Equivalence

Ideal modelling is used in both the continuous and semi-batch 2DiaNF-RO processes to show the proof of equivalence. Mass balance is applied at each membrane stage and each mixing point with the following assumptions: (i) the seawater feed concentration is the same throughout the process, (ii) the recovery ratios (Y₁, Y₂, Y_{RO}) and the rejection ratios of each ion (R_{NF,i}, R_{RO,i}) at each stage and cycle are known and remains unchanged, and (iii) the dilution factor (β) is known and remains unchanged.

With ideal modelling, if the feed flow and concentration at each stage between the continuous and semi-batch designs are the same, all other permeate and retentate outputs will be automatically equal. For this study, only the feed flow and concentration of the NF2 and RO stages are derived because NF1 is always subjected to the same initial conditions. For the continuous 2DiaNF-RO process, the steady state expressions of the flow and feed concentration ratios for the RO and NF2 feed are shown below:

$$\frac{{Q}_{f , RO}}{{Q}_{f , 0}} = \frac{{Y}_{1} + {Y}_{2} ( 1 - {Y}_{1} )}{1 - β {Y}_{RO} {Y}_{2}} \qquad ( 24 )$$

$$\frac{{C}_{f , i , RO}}{{C}_{f , I , 0}} = ( 1 - {R}_{NF , i} ) * \frac{1 - β {Y}_{RO} {Y}_{2}}{1 - β {Y}_{RO} {Y}_{2} ( 1 - {R}_{RO , i} ) ( 1 - {R}_{NF , i} )} * \frac{{Y}_{1} + {Y}_{2} [ 1 - {Y}_{1} ( 1 - {R}_{NF , i )} ]}{{Y}_{1} + {Y}_{2} ( 1 - {Y}_{1} )} \qquad ( 25 )$$

$$\frac{{Q}_{f , 2}}{{Q}_{f , 0}} = \frac{1 - {Y}_{1} ( 1 - β {Y}_{RO} )}{1 - β {Y}_{RO} {Y}_{2}} \qquad ( 26 )$$

$$\frac{{C}_{f , i , 2}}{{C}_{f , i , 0}} = \frac{1 - β {Y}_{RO} {Y}_{2}}{1 - β {Y}_{RO} {Y}_{2} ( 1 - {R}_{RO , i} ) ( 1 - {R}_{NF , i} )} * \frac{1 - {Y}_{1} ( 1 - {R}_{NF , i} ) [ 1 - β {Y}_{RO} ( 1 - {R}_{RO , i} ) ]}{1 - {Y}_{1} ( 1 - β {Y}_{RO} )} \qquad ( 27 )$$

For the semi-batch 2DiaNF-RO process, the expressions of the flow and feed concentration ratios for the RO (i.e., step (b)) and NF2 feed (i.e., step (c)) at the m^{th} cycle are shown below:

$$\frac{{V}_{f , m , b}}{{V}_{f , 0}} = {Y}_{1} + {Y}_{2} * \frac{1 - {( β {Y}_{RO} {Y}_{2} )}^{m - 1}}{1 - β {Y}_{RO} {Y}_{2}} * [ 1 - {Y}_{1} ( 1 - β {Y}_{R O} ) ] \qquad ( 28 )$$

$$\frac{{C}_{f , i , m , b}}{{c}_{f , i , 0}} = ( 1 - {R}_{NF , i} ) * \frac{\begin{matrix}{Y}_{1} + {Y}_{2} * \frac{1 - {( β {Y}_{RO} {Y}_{2} ( 1 - {R}_{RO , i} ) ( 1 - {R}_{NF , i} ) )}^{m - 1}}{1 - ( β {Y}_{RO} {Y}_{2} ( 1 - {R}_{RO , i} ) ( 1 - {R}_{NF , i} )} * \\ [ 1 - {Y}_{1} ( 1 - {R}_{NF , i} ) [ 1 - β {Y}_{RO} ( 1 - {R}_{RO , i} ) ] ]\end{matrix}}{{Y}_{1} + {Y}_{2} * \frac{1 - {( β {Y}_{RO} {Y}_{2} )}^{m - 1}}{1 - ( β {Y}_{RO} {Y}_{2} )} * [ 1 - {Y}_{1} ( 1 - β {Y}_{RO} ) ]} \qquad ( 29 )$$

$$\frac{{V}_{f , m , c}}{{V}_{f , 0}} = \frac{1 - {( β {Y}_{R O} {Y}_{2} )}^{m}}{1 - ( β {Y}_{R O} {Y}_{2} )} * [ 1 - {Y}_{1} ( 1 - β {Y}_{RO} ) ] \qquad ( 30 )$$

$$\frac{{C}_{f , i , m , c}}{{C}_{f , i , 0}} = \frac{\begin{matrix}\frac{( 1 - {( β {Y}_{RO} {Y}_{2} ( 1 - {R}_{RO , i} ) ( 1 - {R}_{NF , i} ) )}^{m} )}{( 1 - β {Y}_{RO} {Y}_{2} ( 1 - {R}_{RO , i} ) ( 1 - {R}_{NF , i} ) )} * \\ [ 1 - {Y}_{1} ( 1 - {R}_{NF , i} ) [ 1 - β {Y}_{RO} ( 1 - {R}_{RO , i} ) ] ]\end{matrix}}{\frac{1 - {( β {Y}_{RO} {Y}_{2} )}^{m}}{1 - β {Y}_{RO} {Y}_{2}} * [ 1 - {Y}_{1} ( 1 - β {Y}_{RO} ) ]} \qquad ( 31 )$$

As the number of cycle approaches infinity (i.e., m→∞), the expressions for the semi-batch design becomes:

$$\frac{{V}_{f , ∞ , b}}{{V}_{f , 0}} = \frac{{Y}_{1} + {Y}_{2} ( 1 - {Y}_{1} )}{1 - β {Y}_{RO} {Y}_{2}} \qquad ( 32 )$$

$$\frac{{C}_{f , i , ∞ , b}}{{C}_{f , i , 0}} = ( 1 - {R}_{NF , i} ) * \frac{1 - β {Y}_{RO} {Y}_{2}}{1 - β {Y}_{R O} {Y}_{2} ( 1 - {R}_{RO , i} ) ( 1 - {R}_{NF , i} )} * \frac{{Y}_{1} + {Y}_{2} [ 1 - {Y}_{1} ( 1 - {R}_{NF , i} ) ]}{{Y}_{1} + {Y}_{2} ( 1 - {Y}_{1} )} \qquad ( 33 )$$

$$\frac{{V}_{f , ∞ , c}}{{V}_{f , 0}} = \frac{1 - {Y}_{1} ( 1 - β {Y}_{RO} )}{1 - β {Y}_{RO} {Y}_{2}} \qquad ( 34 )$$

$$\frac{{C}_{f , i , ∞ , c}}{{C}_{f , i , 0}} = \frac{1 - β {Y}_{RO} {Y}_{2}}{1 - β {Y}_{RO} {Y}_{2} ( 1 - {R}_{RO , i} ) ( 1 - {R}_{NF , i} )} * \frac{1 - {Y}_{1} ( 1 - {R}_{NF , i} ) [ 1 - β {Y}_{RO} ( 1 - {R}_{RO , i} ) ]}{1 - {Y}_{1} ( 1 - β {Y}_{RO} )} \qquad ( 35 )$$

As equations (32)-(35) are equal one-on-one to equations (28)-(31), the ideal modelling has shown that there is an equivalence between the semi-batch 2DiaNF-RO at a very large cycle with the continuous 2DiaNF-RO at steady state. Hence, the semi-batch experiment could be used to evaluate the volume and concentration in the continuous design.

The absolute percentage error (APE) of the NF2 feed parameters, such as volume ratios or concentration factors, in the 2 consecutive cycles was used as an indicator for the steady state. NF2 feed was chosen because it represented one of the 2 important mixing points. Volume ratio and concentration factor (CF) were employed to normalize the difference in the initial seawater conditions between cycles. Steady state was assumed when APE at the i^{th} cycle of the semi-batch was less than 5.0%.

$$A P {E}_{{CF}_{A} , i} = \frac{\vert C {F}_{f , A , i} - C {F}_{f , A , i - 1} \vert}{C {F}_{f , A , i - 1}} , 2 \leq i \leq m \qquad ( 36 )$$

Where APE_{CF}_{_{A}}_{^{,i}} is the error of CF of solute A between cycle i^{th} and cycle (i-1)^{th}; i is the current cycle; CF_{f,A,i}, CF_{f,A,i-1} are the concentration factors of solute A at NF2 feed in i^{th} and (i-1)^{th} cycles, respectively.

Mean absolute percentage error (MAPE) between the simulation and batch experiment was used to justify the accuracy of the model. Using CF1 of solute A as an example for the output indicator, MAPE is calculated as follows:

$$M A P {E}_{CF {1}_{A}} = \frac{1}{k} {\sum }_{j = 1}^{k} {( \frac{\vert C F {1}_{A , sim} - C F {1}_{A , e xp} \vert}{C F {1}_{A , e xp}} )}_{j} \qquad ( 37 )$$

Where k is the number of sample points for validation; CF1_{A,sin}, CF1_{A,exp} are the CF1 of solute A in simulation and experiment, respectively, under the same input conditions.

TABLE 5
Test conditions of the equivalent
semi-batch 2DiaNF-RO experiment

| | Input values | |
|---|---|---|
| Seawater feed | 32.7 g/L with 5 ions (Na⁺, Mg²⁺, | |
| | Ca²⁺, Cl⁻, SO₄²⁻) | |
| Seawater volume | 10 | L |
| Membrane type | NF270 and SW30HR | |
| Membrane area | 0.0214 | m² |
| Membrane module | Flat sheet filtration cell | |
| Cross flow velocity | 0.40 | L/min |
| Temperature | 25 | |
| NF1 pressure | 15.54 + 0.12 | bar |
| NF2 pressure | 15.61 + 0.19 | bar |
| RO pressure | 50.86 + 0.29 | bar |

| | |
|---|---|
| NF1 recovery | 0.708 + 0.010 |
| NF2 recovery | 0.702 + 0.002 |
| RO recovery | 0.452 + 0.002 |

### Model Validation

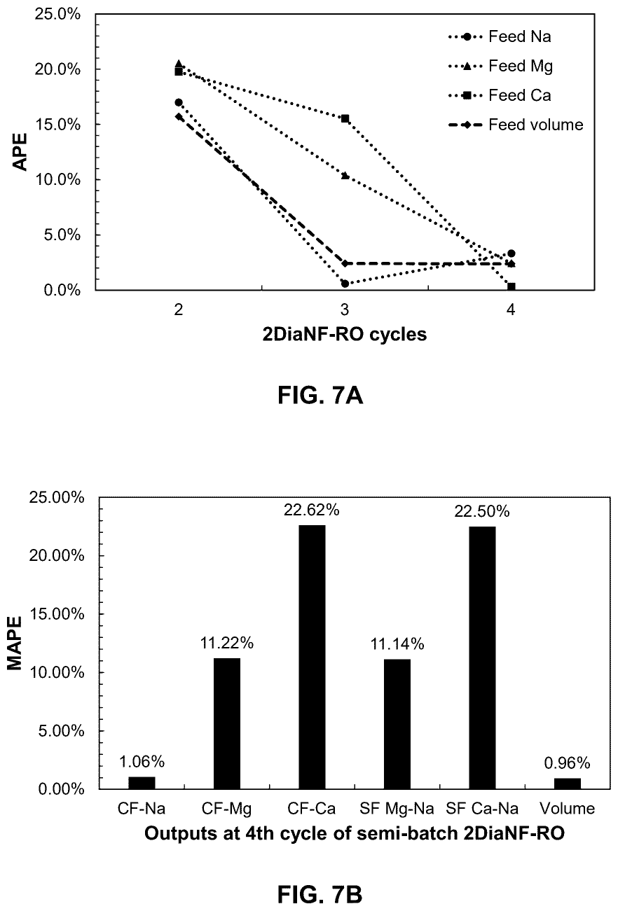

The semi-batch reached the equivalent steady state after 4 cycles. Referring to FIG. 7A and FIG. 7B, the APEs at the 4th cycle of NF2 feed volume ratio and cation feed concentration factors were less than 5.0%. Since there was reasonably small variation in the NF2 feed outputs between the 3rd and 4th cycles, the results at the 4^{th} cycle were assumed to be at steady state.

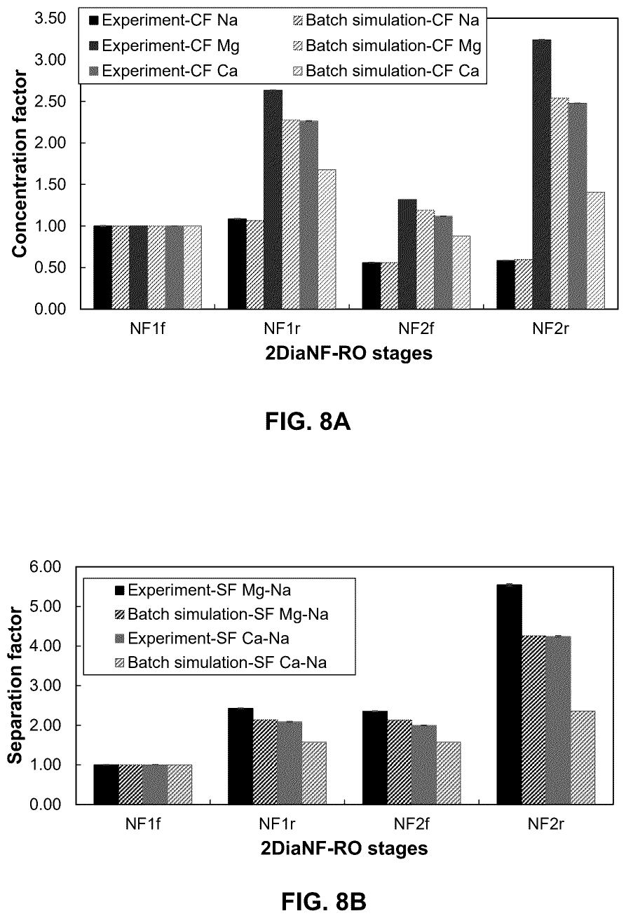

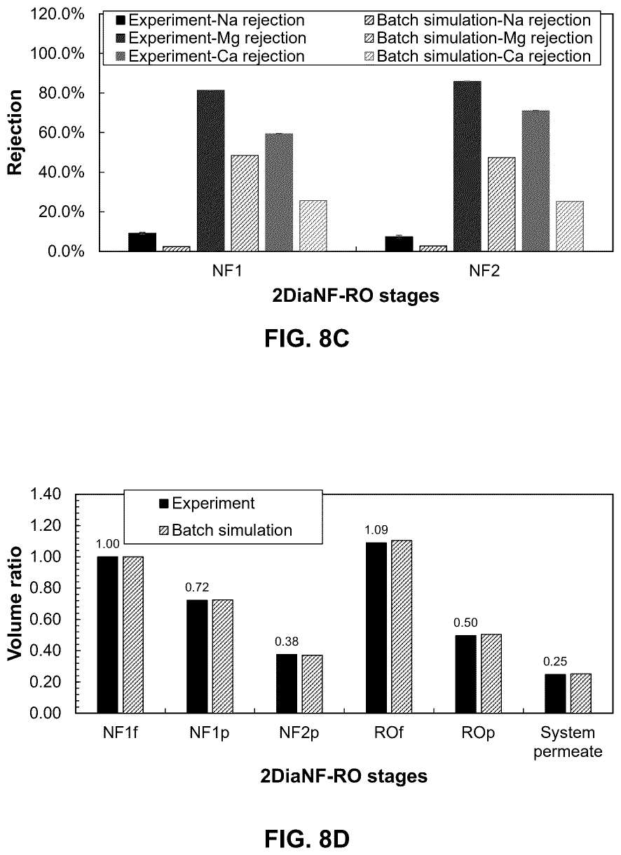

In FIG. 8A, the experimental 2DiaNF-RO process achieved both monovalent cation dilution (i.e., CF1Na<1) and divalent cations concentration (i.e., CF1Mg>1 and CF1Ca>1) in NF2 brine at m=4 (i.e., Br1 in continuous design), which resulted in the high divalent-monovalent separation factors (SF1) of Mg—Na and Ca—Na.

There were two main mechanisms that facilitated such effective fractionation in 2DiaNF-RO. The first mechanism was from the distinct difference in monovalent and divalent ion rejection in NF membrane, as observed in FIG. 8C, which allowed a much greater concentration of divalent ions than monovalent ions in NF1 and NF2 retentate streams.

The second mechanism was from the diafiltration step between NF1 retentate and NF2 feed, which had a significant effect on monovalent ions dilution. In this case, they were all diluted by 50% on average.

Mg²⁺ and Ca²⁺ ions are both positively charged with the Stoke radii of 0.347 and 0.309 nm, respectively. In the synthetic seawater solution, Mg²⁺ was rejected more than Ca²⁺ by the NF270 steric hindrance mechanism. Thus, the experimental batch 2DiaNF-RO with NF270 had higher SF1_{Mg—Na} than SF1_{Ca-Na}, as shown in FIG. 8B.

In terms of desalination, the experimental 2DiaNF-RO process achieved the system water recovery of 24.8% because half of the RO permeate volume was used as diluent. FIG. 8D shows that by using the cumulative NF permeate volumes, the RO could receive the higher feed volume than the initial seawater volume.

This allowed the volume ratio of RO permeate to be 0.50 though the RO recovery was fixed at 45%. It was also shown that RO membrane permeability was the main desalination efficiency bottleneck of the semi-batch 2DiaNF-RO. Better water recovery could be obtained if the RO membrane permeability was improved.

Simulation results of the semi-batch 2DiaNF-RO were presented for validation purposes. FIG. 8A also shows that the simulation generally underestimated the CF of cations, because it predicted lower NF cation rejections, as indicated in FIG. 8C.

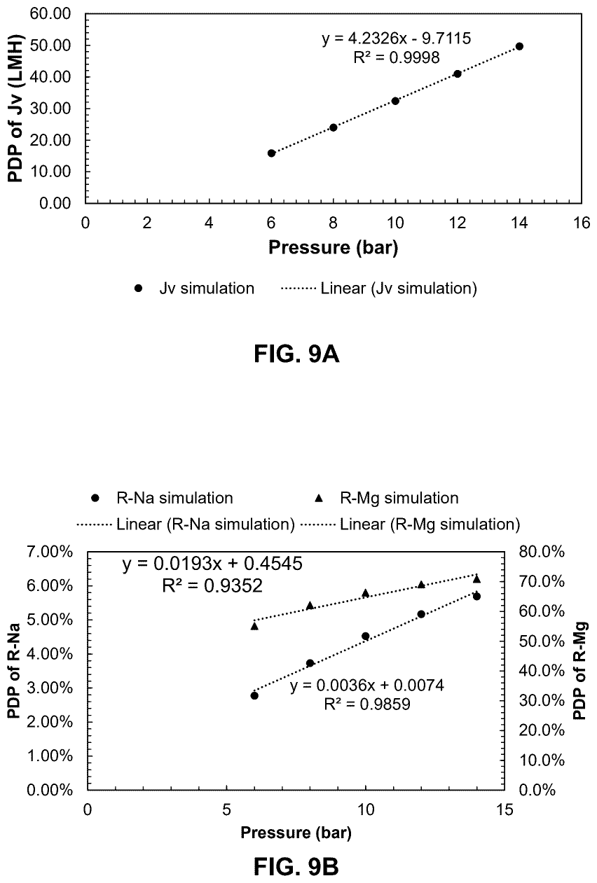

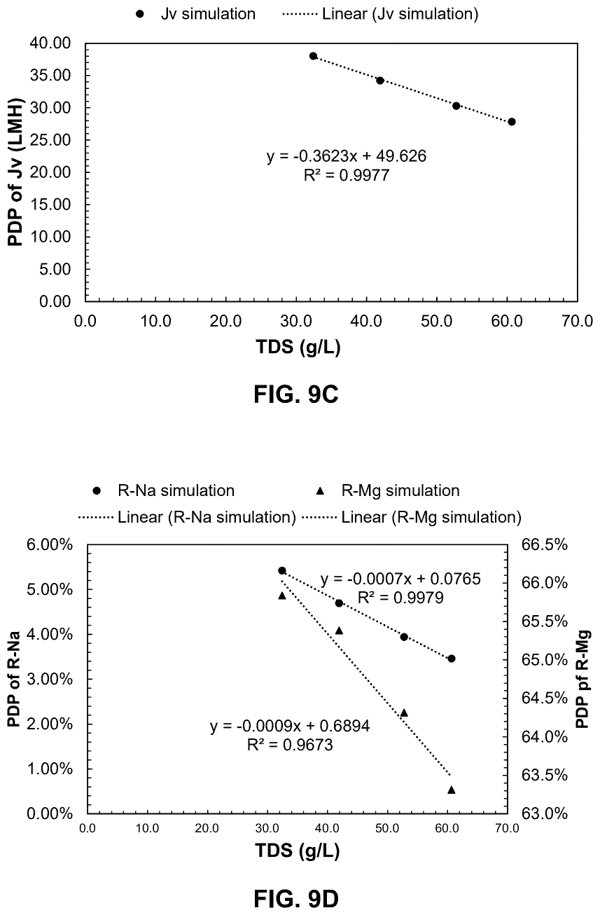

From the partial dependence plots (PDP) in FIG. 9A to FIG. 90, the non-horizontal lines emphasized how the S—K model moderately biased the input data (i.e., feed pressure and TDS concentration). Due to the discrepancy between the fitted and validated NF membranes, the simulation accuracy was compromised accordingly. Such underestimation had a more significant effect on divalent ion than on monovalent ion concentration because divalent ions were concentrated more at each stage (i.e., higher rejection).

Referring again to FIG. 7B, the MAPEs of CF1_{Mg} and CF1_{Ca} were 11.2% and 22.6%, respectively, while MAPE of CF1_{Na} were 1.06%. Hence, the SF1 s were underestimated by the simulation in all stages (FIG. 8B). Specifically, the MAPE of SF1_{Mg—Na} and SF1_{Ca-Na} were 11.1% and 22.5%, respectively. Thus, this result implies that the experimental 2DiaNF-RO could achieve a better separation performance in Br1 than the simulation predictions.

For volume ratios, the batch simulation accurately predicted the outputs across the stages with a low MAPE of 0.93% (FIG. 7B) due to the fixed recovery assumption in this experiment. The simulation slightly overestimated the volume ratio because of the sampling loss during experiment, but its effect was small enough to be negligible. Overall, based on the highest MAPE, the model could predict the 2DiaNF-RO performance with at least 77.4% accuracy. However, if only Na⁺ and Mg²⁺ were considered, the highest error was reduced to 11.22%, which corresponded to an accuracy of at least 88.8%.

### Sensitivity Analysis

Local sensitivity analysis, where each independent variable is changed one-at-a-time, was used to identify the impact of each input (i.e., diluent-RO permeate ratio (β), NF/RO pressure, and retentate recycle ratio) on the output performance of the 2DiaNF-RO process. For this study, YRO was fixed at 0.45 to match the global average water recovery of SWRO desalination. This ensures that the RO safety factor (i.e., ratio of retentate to permeate flow rate) was more than 1, so RO retentate recycling was not necessary. For other inputs, their base operating conditions and analysis ranges are shown in Table 6.

TABLE 6
Input variable ranges in the local
sensitivity analysis of 2DiaNF-RO

| Input variables | Base values | Analysis range |
|---|---|---|
| β₁ | 0.0 | 0.0-0.4 |
| β₂ | 0.5 | 0.3-0.7 |
| P₁ (bar) | 18 | 16-20 |
| P₂ (bar) | 10 | 7-11 |
| P_{RO} (bar) | 50 | 45-55 |
| Rec₁ | 0.0 | 0.0-0.3 |
| Rec₂ | 0.0 | 0.0-0.4 |

### Performance Criteria

Various approaches may be used to determine the performance criteria for effective ion fractionation at modest energy consumption and practical resource recovery.

For example, more Mg²⁺:Na⁺ ratio should be present in Br1 than in the initial seawater feed after the process, so large SF1_{Mg—Na} is preferred. With diafiltration, SF1_{Mg—Na} can be maximized by simultaneously concentrating Mg²⁺ (i.e., CF1_{Mg}>1.0) and diluting Na⁺ (i.e., CF1Na<1.0). For example, the process should operate at reasonable energy so net SEC is minimized. For the RO process treating TDS from 30 to 70 g/L, the range of net SEC is from 2 to 6 kWh/m³. Specifically, if high pressure and high recovery is required for the concentrated brine feed, the range of SEC could be higher. For instance, a conventional high-pressure RO (HPRO) need 3 kWh/m³ to 9 kWh/m³ to treat 70 g/L TDS. Another conventional osmotically assisted RO (OARO) required 6 kW/m³ to 19 kWh/m³ to treat 100-140 g/L TDS. Yet another conventional nRO-NF system needed 11 kW/m³ to 20 kWh/m³ for ZLD applications.

Advantageously, the proposed nDiaNF-RO system could be used to fractionate and concentrate two different brine streams for subsequent resource recovery without a need for the highly concentrated feed required by the conventional examples. As such, it was more reasonable to compare the SEC of nDiaNF-RO with that of RO-based brine management technology, rather than with a typical SWRO for desalination. Hence, to be competitive, the SECₙₑₜ for nDiaNF-RO is preferably less than 6.0 kWh/m³, which was the upper SEC limit of a single-stage RO treating high salinity feed. From sensitivity analysis, NF pressure and element numbers were chosen as input variables, while other operating conditions were kept at the baseline values. Overall, the constrained bi-objective optimization problem for the nDiaNF-RO include are:

$$max {f}_{1} = S F {1}_{Mg - Na}$$

$$min {f}_{2} = S E {C}_{net}$$

$$subjected to : {g}_{1} = S E {C}_{net} \leq 6. kWh / {m}^{3}$$

$$with : 6 bar \leq {P}_{1} , {P}_{2} , … , {P}_{n} \leq 20 bar$$

$$3 \leq {elem}_{1} , {elem}_{2} , … , {elem}_{n} \leq 8$$

$${P}_{1} , … , {P}_{n} , {elem}_{1} , … , {elem}_{n} ∈ ℤ$$

In the experiments, the non-dominated sorting genetic algorithm II (NSGA II) was used to solve the multi-objective optimization problem above, using the pymoo framework in Python (see, e.g., github.com/anyoptimization/pymoo).

Briefly, it involved finding and sorting the solutions into non-dominated sets in the objective space, where no element in the set was better in both f1 and f2 than any other element (i.e., non-dominated to each other). Among the solution sets, the most optimal one was found by applying genetic algorithm to the input variables. Here, the inputs were subjected to various processes, including selection, crossover, and mutation, to create the solutions that tried to satisfy all the constraints and criteria. The procedure was then repeated with many generations (i.e., cycles), where only the best solutions survived and advanced to the next generation. The optimization was stopped when the convergence condition was met, which was determined by the hypervolume indicator. For this example, 20 population inputs with 25 generations (i.e., 500 function evaluations) were shown to be sufficient to reach optimization results.

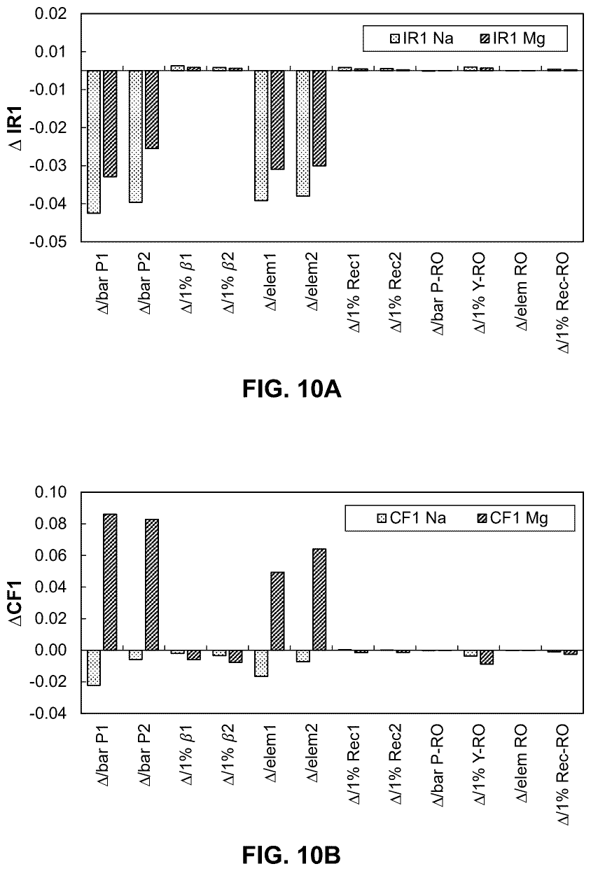

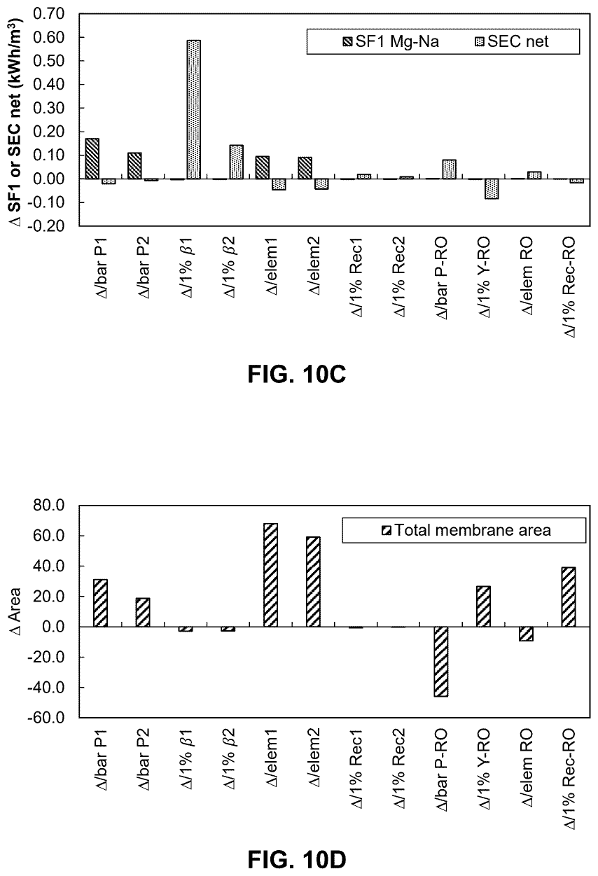

FIG. 10A to FIG. 10D show the changes of various output indicators with respect to a unit increase in each operating variable. The values were obtained from the slope of the linear regression during the sensitivity analysis. FIG. 10A shows that the reduction of IR1_{Na} and IR1_{Mg} were most sensitive by the increase in NF pressure and number of elements. This was because high pressure increased the permeate flux and large area allowed more ions permeation. Hence, more ion mass was “washed out” to the permeate side.

Referring to FIG. 10B, high NF pressure and element number were shown to facilitate Na⁺ dilution and Mg²⁺ concentration, because more diluent became available from the high NF flux and membrane area, while the NF retentate flow became more concentrated. This also explains how Mg—Na fractionation was most influenced by NF pressure and element number, as shown by the SF1_{Mg—Na} in FIG. 10C.

Operating at high pressure and with many elements may require a large total area (FIG. 10D), which might incur additional cost and footprint. It was observed that Na⁺ dilution was more sensitive to P1 than P2. Due to the slightly higher P1 analysis range (Table 6) to overcome the more concentrated solution at NF1 feed, higher NF1 451 flux (Eq. (1)) and permeate volume (Eq. (11)) were produced than NF2 per unit change of pressure, which led to the higher diluent volume. As such, the SF1_{Mg—Na} was slightly more sensitive to P1 than P2.

In terms of energy consumption, FIG. 10C shows that SECₙₑₜ was most sensitive to β₁ and β₂ increase because they reduced the product water volume. However, their values could not be too low because β₁ and β₂ controlled the main dilution pathway from RO and were the third most important factor in ion dilution, after NF element number and pressure (FIG. 10B). The present system advantageously enables a practical way to reduce SECₙₑₜ via higher RO water recovery (Y_{RO}). On average, 0.5 kWh/m³ was saved for every 6.0% increase in Y_{RO}.

In the example of a single-stage RO, Y_{RO} was set at 45.0% to match worldwide average and ensure a less-than-one safety factor. Optionally, more energy saving or dilution is achievable (e.g., Y_{RO} can be improved) by using a higher recovery process in this stage, such as but not limited to an energy efficient reverse osmosis (EERO) process.

In general, SF and SEC were not very sensitive to retentate recycle variation in NF and RO stages. This indicates that if high NF or RO recovery were required, retentate recycling could be applied to maintain the safety factor of each stage. Here, to simplify calculation, operation without retentate recycling was assumed. It is conceivable that Rec (recycling for more than one pass through a membrane stage) may be implemented to mitigate the effect of scaling and fouling in membrane stages.

Assuming β₁+β₂=0.5, the effects of different p combination are shown in FIG. 11A to FIG. 11D. As the dilution emphasis was shifted from NF2 to NF1 (i.e., β₁ increased and β₂ decreased), both SF1_{Mg—Na} and SECₙₑₜ were worsened. For ion fractionation, due to the higher feed flow in NF1 than in NF2, the dilution factor at NF1 feed was lower, which led to less dilution (i.e., higher CF1) and lower SF1_{Mg—Na} as shown. For energy consumption, supplying the diluent in NF1 generally required higher pressure, which resulted in higher pumping demand. Since there were limited changes in product water volume, the SECₙₑₜ was increased.

Shifting dilution to NF1 could improve both IR1 and the total area. Without being limited by theory, this was because less ion mass was “washed out” at NF1 feed dilution, leading to higher brine concentration. Since NF often produced higher permeate flow from higher pressure, higher NF1 feed flow from dilution also reduced the RO feed osmotic pressure, which increased RO flux and reduced area required. The performance of the nDiaNF-RO system is thus shown to be advantageously configurable by selecting a p combination.

In one example, β₁= . . . =βₙ₋₁=0 and βₙ=0.5 were selected as baseline values in view of the dual objectives of the optimization process (e.g., to maximize SF1_{Mg—Na} and minimize SECₙₑₜ). The total water withdrawal ratio (i.e., Σᵢ₌₁ⁿ βᵢ) was kept at 0.5 to facilitate both ion dilution and energy saving. Depending on the actual results, this ratio could be adjusted accordingly.

Based on the sensitivity analysis, the retentate recycle ratio (Rec), diluent to RO permeate ratio (β), RO pressure, and RO water recovery may be kept at the baseline values since they did not significantly affect SF1_{Mg—Na} or SECₙₑₜ. The chosen RO baseline values were also similar to those in the safe operating window for minimum SEC of SW30HR. In such a case, the NF pressure and number of elements are the optimizing variables.

Exemplary nDiaNF-RO Performance

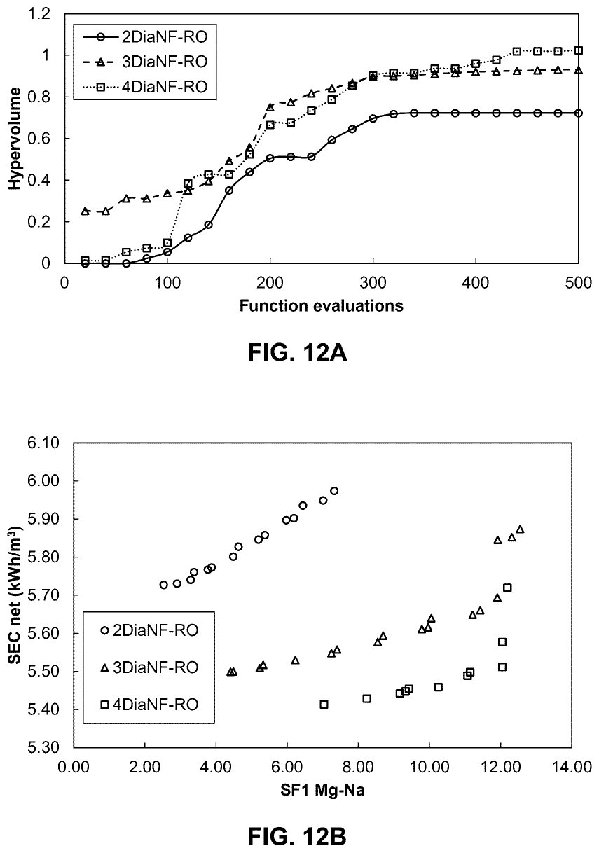

Over 500 evaluations were performed. FIG. 12A shows that convergence could be obtained by all procedures with the hypervolume indicators reaching stable values. At the termination points, the optimal results are shown in FIG. 12B, while the optimal operating conditions (i.e., NF pressure and number of elements per PV) are described in Table 7A-1 and 7A-2.

TABLE 7A-1
Optimal operating conditions of nDiaNF-RO, for n = 2, 3, 4

| | P1 | P2 | P3 | P4 |
|---|---|---|---|---|
| n | (bar) | (bar) | (bar) | (bar) |
| 2 | 12 | 9 | 8 | 8 |
| 2 | 13 | 9 | 8 | 8 |
| 2 | 13 | 10 | 8 | 8 |
| 2 | 14 | 9 | 8 | 8 |
| 2 | 13 | 11 | 8 | 8 |
| 2 | 14 | 10 | 8 | 8 |
| 2 | 14 | 11 | 8 | 8 |
| 2 | 15 | 10 | 8 | 8 |
| 2 | 14 | 12 | 8 | 8 |
| 2 | 15 | 11 | 8 | 8 |
| 2 | 14 | 13 | 8 | 8 |
| 2 | 15 | 12 | 8 | 8 |
| 2 | 16 | 11 | 8 | 8 |
| 2 | 15 | 13 | 8 | 8 |
| 2 | 16 | 12 | 8 | 8 |
| 3 | 11 | 9 | 7 | 8 |
| 3 | 11 | 9 | 8 | 8 |
| 3 | 12 | 9 | 7 | 8 |
| 3 | 12 | 9 | 8 | 8 |
| 3 | 12 | 10 | 7 | 8 |
| 3 | 12 | 10 | 8 | 8 |
| 3 | 12 | 10 | 9 | 8 |
| 3 | 12 | 11 | 8 | 8 |
| 3 | 12 | 11 | 9 | 8 |
| 3 | 12 | 12 | 8 | 8 |
| 3 | 13 | 11 | 9 | 8 |
| 3 | 12 | 12 | 9 | 8 |
| 3 | 12 | 13 | 8 | 8 |
| 3 | 13 | 12 | 9 | 8 |
| 3 | 12 | 13 | 9 | 8 |
| 3 | 13 | 13 | 9 | 8 |
| 3 | 14 | 16 | 9 | 8 |
| 3 | 13 | 17 | 9 | 8 |
| 3 | 14 | 16 | 9 | 7 |
| 4 | 11 | 8 | 9 | 7 |
| 4 | 11 | 8 | 9 | 8 |
| 4 | 11 | 9 | 9 | 8 |
| 4 | 11 | 8 | 10 | 8 |
| 4 | 11 | 8 | 9 | 9 |
| 4 | 11 | 9 | 10 | 8 |
| 4 | 12 | 10 | 9 | 8 |
| 4 | 13 | 8 | 10 | 8 |
| 4 | 13 | 9 | 10 | 8 |
| 4 | 12 | 10 | 13 | 8 |
| 4 | 9 | 14 | 13 | 8 |

TABLE 7A-2
Optimal operating conditions of nDiaNF-RO, for n = 2, 3, 4

| | | | | | | SEC |
|---|---|---|---|---|---|---|
| n | Elem 1 | Elem 2 | Elem 3 1 | Elem 4 | SF1_{MgNa} | (kWh/m³) |
| 2 | 2.53 | 5.73 | — | — | — | — |
| 2 | 2.9 | 5.73 | — | — | — | — |
| 2 | 3.29 | 5.74 | — | — | — | — |
| 2 | 3.38 | 5.76 | — | — | — | — |
| 2 | 3.77 | 5.77 | — | — | — | — |
| 2 | 3.88 | 5.77 | — | — | — | — |
| 2 | 4.48 | 5.8 | — | — | — | — |
| 2 | 4.63 | 5.83 | — | — | — | — |
| 2 | 5.19 | 5.85 | — | — | — | — |
| 2 | 5.37 | 5.86 | — | — | — | — |
| 2 | 5.97 | 5.9 | — | — | — | — |
| 2 | 6.19 | 5.9 | — | — | — | — |
| 2 | 6.45 | 5.94 | — | — | — | — |
| 2 | 7.01 | 5.95 | — | — | — | — |
| 2 | 7.32 | 5.97 | — | — | — | — |
| 3 | 8 | 8 | 3.81 | 5.49 | — | — |
| 3 | 8 | 8 | 4.41 | 5.5 | — | — |
| 3 | 8 | 8 | 4.49 | 5.5 | — | — |
| 3 | 8 | 8 | 5.23 | 5.51 | — | — |
| 3 | 8 | 8 | 5.33 | 5.52 | — | — |
| 3 | 8 | 8 | 6.23 | 5.53 | — | — |
| 3 | 8 | 8 | 7.24 | 5.55 | — | — |
| 3 | 8 | 8 | 7.4 | 5.56 | — | — |
| 3 | 8 | 8 | 8.55 | 5.58 | — | — |
| 3 | 8 | 8 | 8.7 | 5.59 | — | — |
| 3 | 8 | 8 | 9.79 | 5.61 | — | — |
| 3 | 8 | 8 | 9.96 | 5.62 | — | — |
| 3 | 8 | 8 | 10.05 | 5.64 | — | — |
| 3 | 8 | 8 | 11.21 | 5.65 | — | — |
| 3 | 8 | 8 | 11.43 | 5.66 | — | — |
| 3 | 8 | 7 | 11.91 | 5.69 | — | — |
| 3 | 5 | 7 | 11.92 | 5.85 | — | — |
| 3 | 5 | 8 | 12.32 | 5.85 | — | — |
| 3 | 6 | 7 | 12.55 | 5.87 | — | — |
| 4 | 8 | 8 | 7 | 8 | 7.04 | 5.41 |
| 4 | 8 | 8 | 7 | 8 | 8.24 | 5.43 |
| 4 | 8 | 8 | 7 | 8 | 9.17 | 5.44 |
| 4 | 8 | 8 | 7 | 8 | 9.33 | 5.45 |
| 4 | 8 | 8 | 7 | 8 | 9.43 | 5.45 |
| 4 | 8 | 8 | 7 | 8 | 10.25 | 5.46 |
| 4 | 8 | 8 | 7 | 8 | 11.07 | 5.49 |
| 4 | 8 | 8 | 7 | 8 | 11.15 | 5.5 |
| 4 | 8 | 8 | 7 | 8 | 12.05 | 5.51 |
| 4 | 4 | 8 | 7 | 8 | 12.05 | 5.58 |
| 4 | 4 | 8 | 5 | 8 | 12.19 | 5.72 |

With the NSGA-II algorithm, the constrained bi-objective problem to minimize energy consumption (i.e., SECₙₑₜ) and maximize the Mg—Na ion fractionation in Br1 (i.e., SF1_{MgNa}) of nDiaNF-RO pilot process was solved. Non-dominated solution sets were obtained for each case of n=2,3,4. The optimal NE pressure and element numbers are described in Tables 7A to 7D, while other operating conditions are at baseline values.

The optimal ion concentration results at selected operating conditions (i.e., at the lowest and highest maximum SF) are shown in the Tables 7B, 7C, 7D, for Brine 1 (Br1), Brine 2 (Br2), and Product water (PW), respectively. They include the 5 dominant ions in seawater (i.e., Na, Mg, Ca, Cl, SO₄).

TABLE 7B
Optimal ion concentration in Brine 1 (Br1) of nDiaNF-
RO, for the lowest and highest maximum SF at each n

| | | SECₙₑₜ | Na⁺ | Mg²⁺ | Ca²⁺ | SO₄²⁻ | Cl⁻ | TDS |
|---|---|---|---|---|---|---|---|---|
| n | SF1_{MgNa} | (kWh/m³) | (mg/L) | (mg/L) | (mg/L) | (mg/L) | (mg/L) | (mg/L) |
| 2 | 2.53 | 5.73 | 8305 | 2633 | 481 | 6583 | 17106 | 35108 |
| 2 | 7.32 | 5.97 | 5993 | 5502 | 619 | 28233 | 14141 | 54488 |
| 3 | 3.81 | 5.49 | 5656 | 2704 | 395 | 9529 | 12084 | 30368 |
| 3 | 12.55 | 5.87 | 1862 | 2928 | 238 | 27211 | 4560 | 36799 |
| 4 | 7.04 | 5.41 | 2755 | 2430 | 250 | 16144 | 6209 | 27787 |
| 4 | 12.19 | 5.72 | 1619 | 2474 | 197 | 25947 | 3904 | 34140 |

TABLE 7C
Optimal ion concentration in Brine 2 (Br2) of nDiaNF-
RO, for the lowest and highest maximum SF at each n

| | | SECₙₑₜ | Na⁺ | Mg²⁺ | Ca²⁺ | SO₄²⁻ | Cl⁻ | TDS |
|---|---|---|---|---|---|---|---|---|
| n | SF1_{MgNa} | (kWh/m³) | (mg/L) | (mg/L) | (mg/L) | (mg/L) | (mg/L) | (mg/L) |
| 2 | 2.53 | 5.73 | 17249 | 1252 | 481 | 457 | 30379 | 49818 |
| 2 | 7.32 | 5.97 | 16073 | 1622 | 518 | 834 | 29079 | 48126 |
| 3 | 3.81 | 5.49 | 17333 | 1554 | 534 | 701 | 31101 | 51222 |
| 3 | 12.55 | 5.87 | 16283 | 1856 | 548 | 1255 | 29650 | 49592 |
| 4 | 7.04 | 5.41 | 16755 | 1824 | 556 | 1132 | 30435 | 50702 |
| 4 | 12.19 | 5.72 | 16263 | 1888 | 550 | 1398 | 29631 | 49730 |

TABLE 7D
Optimal ion concentration in Product water (PW) of nDiaNF-
RO, for the lowest and highest maximum SF at each n

| | | SECₙₑₜ | Na⁺ | Mg²⁺ | Ca²⁺ | SO₄²⁻ | Cl⁻ | TDS |
|---|---|---|---|---|---|---|---|---|
| n | SF1_{MgNa} | (kWh/m³) | (mg/L) | (mg/L) | (mg/L) | (mg/L) | (mg/L) | (mg/L) |
| 2 | 2.53 | 5.73 | 107 | 2.87 | 1.16 | 0.7 | 161 | 273 |
| 2 | 7.32 | 5.97 | 89 | 3.33 | 1.11 | 1.15 | 138 | 233 |
| 3 | 3.81 | 5.49 | 116 | 3.84 | 1.38 | 1.16 | 178 | 300 |
| 3 | 12.55 | 5.87 | 97 | 4.07 | 1.26 | 1.84 | 150 | 254 |
| 4 | 7.04 | 5.41 | 107 | 4.3 | 1.37 | 1.78 | 165 | 280 |
| 4 | 12.19 | 5.72 | 97 | 4.15 | 1.27 | 2.06 | 150 | 255 |

The optimal non-dominated solution sets indicated that there was no single point that had both minimum SECₙₑₜ and maximum SF1_{Mg-Na}. In other words, minimizing energy requires compromise in ion fractionation and vice versa. The results also show that more NF stages generally expanded the range of minimum SECₙₑₜ and maximum SF1_{Mg-Na}.

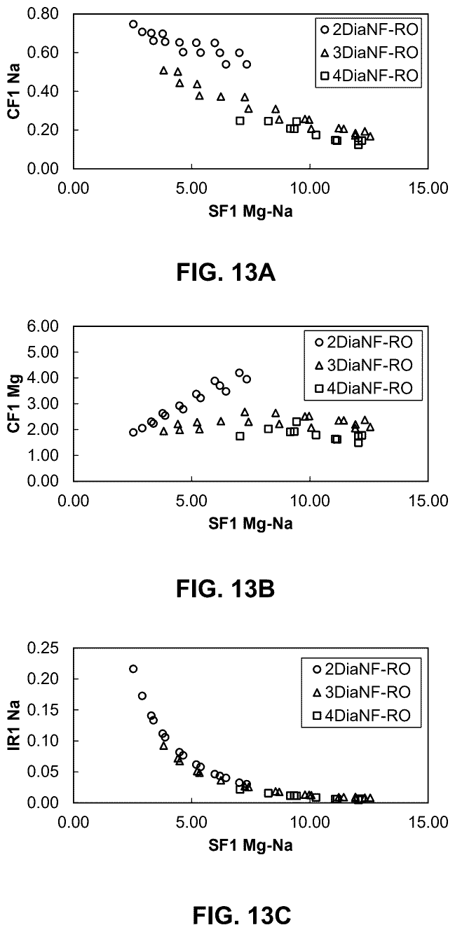

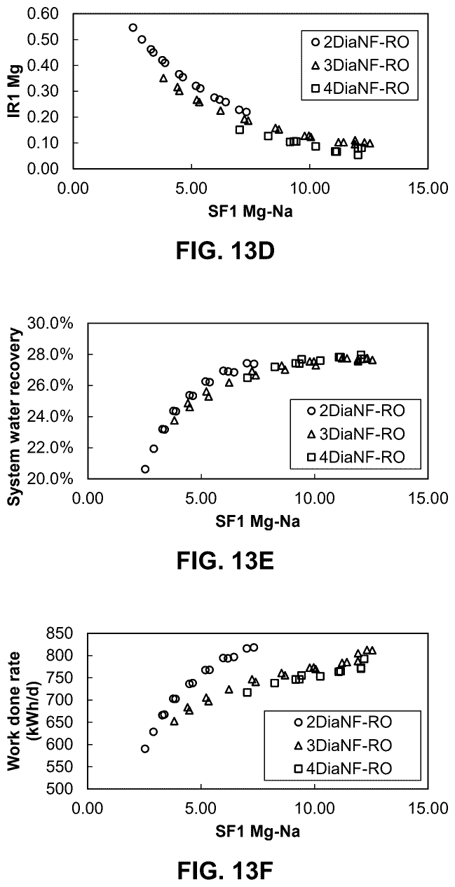

For instance, the 4DiaNF-RO achieved the maximum SF1_{Mg-Na}=12.19 at 5.72 kWh/m³ while the 2DiaNF-RO obtained a SF1_{Mg-Na}=2.53 at its minimum SECₙₑₜ=5.73 kWh/m³. The reason was from the enhanced dilution effect from the additional NF stages, which could be observed from the CF1 behavior. From FIG. 13A and FIG. 13B, it can be seen that 2DiaNF-RO improved its SF1_{Mg—Na} mainly by Mg concentration (i.e., increasing CF1_{Mg}), while 3DiaNF-RO and 4DiaNF-RO preferred the Na dilution approach (i.e., decreasing CF1Na).

This shows that dilution had a more crucial role in improving the Mg—Na selectivity, and this was achieved by having more stages in diafiltration. To have a positive Mg—Na ratio in Br1, SF1_{Mg—Na} should be more than 8.0, which is the initial Na—Mg in seawater feed. Coupled with the SECₙₑₜ<6.0 kWh/m³ requirement, 3DiaNF-RO and 4DiaNF-RO configurations were shown to satisfy the preferred criteria more frequently.

Despite a significant expansion of the optimal objective space when n was increased from 2 to 3, the expansion became diminishing when n was increased to 4, e.g., 4DiaNF-RO theoretically resulted in improved performance. Other operational factors (e.g., capital cost, ease of control, etc.,) may also be considered when choosing n, to ensure that the performance improvement would be worth the cost.

FIG. 13C and FIG. 13D show an inverse relationship between Mg—Na selectivity and ion recovery in Br1. Despite having high SF1_{Mg-Na}, 3DiaNF-RO and 4DiaNF-RO only had around 10% Mg recovery in Br1 for the selectivity from 10.0 to 12.0. This was due to the larger ion “wash out” at the dilution step, e.g., more Na⁺ was “washed out” than Mg²⁺. To recover more than 50% Mg²⁺ in Br1, the maximum SF1_{Mg—Na} obtained with the current NF membrane was 2.90. At the current operating conditions, only 2DiaNF-RO could satisfy such constraint.

To achieve the Br1 stream that is both Mg-dominant (i.e., high SF1_{Mg-Na}) and Mg-rich (i.e., high IR1_{Mg}), a NF membrane with better Mg²⁺ rejection may be selected for use in the system 100, to allow more Mg²⁺ mass retention even under high diafiltration. Given the present disclosure, one skilled in the art would not find it onerous to try different configurations (e.g., different number of stages) so that the preferred performance could be obtained in fewer stages. This will ensure that not only does the nDiaNF-RO improve the ion fractionation effectiveness, but it also has reasonable practicality for industrial implementation, taking cost into consideration.

FIG. 13E and FIG. 13F show that as SF1_{Mg—Na} increased, the net work done rate became gradually higher due to the higher pressure requirement at high SF1_{Mg-Na}. Concurrently, the system water recovery gradually approached the upper limit of 28.0% because the NF permeability limited the total NF permeate flow (i.e., RO feed flow) to less than 622 m³/d at the current assumed bounds of NF pressure, NF element number, and diluent withdrawal ratio (β). Hence, the minimum SECₙₑₜ was shown to increase with the maximum SF1_{Mg-Na}.

### Effects of Membrane Performance

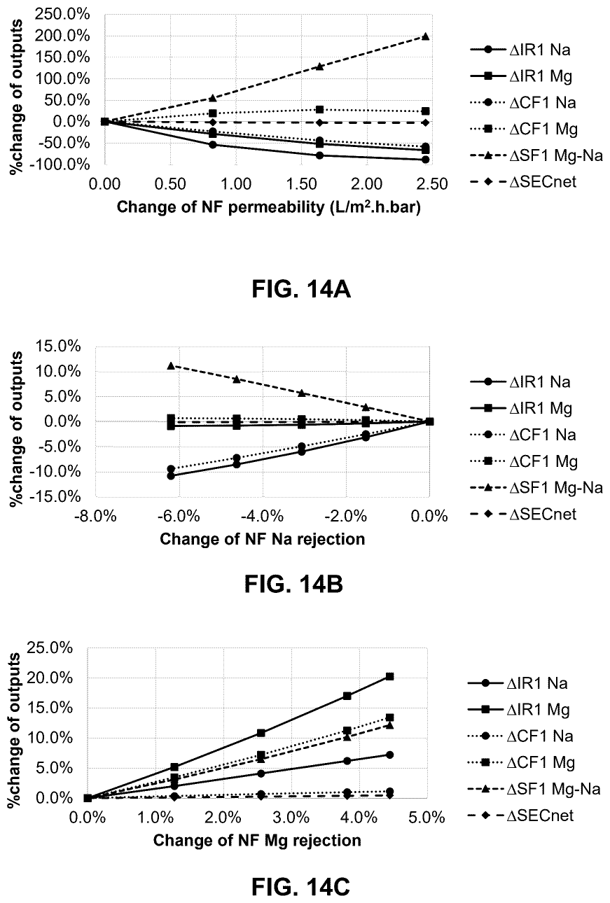

FIG. 14A shows that ion recovery in Br1 was very sensitive to higher NF water permeability. Both IR1 Na and IR1_{Mg} were reduced by 35.8% and 27.4% per 1.0 L/m²·h·bar, respectively, because more ions were “washed out” from the higher diluent volume available. Both Na dilution and Mg concentration were also sensitive to the increase of NF water permeability, which explained its large impact on the SF1_{Mg—Na} improvement in Br1 (+81.9% per 1.0 L/m²·h·bar). This was because high NF permeability induced both higher diluent production and retentate concentration. Such changes also increased the system water recovery (+9.63% per 1.0 L/m²·h·bar) and reduced the SECₙₑₜ (−1.19% per 1.0 L/m²·h·bar), but the effects were not as strong as those in ion fractionation.

FIG. 14B demonstrates that only IR1_{Na} and CF1_{Na} were significantly reduced by the Na rejection decrease, leading to a rise in SF1_{Mg—Na} (+1.80% per 1.0% R_{Na} decrease). As shown in FIG. 14C, if higher Mg rejection was applied, not only did the IR1_{Mg} and CF1_{Mg} increase, but the IR1 Na and CF1_{Na} also rose slightly. This resulted in a decent SF1_{Mg}/Na increase (+2.73% per 1.0% R_{Mg} increase).

Here, Mg—Na ion fractionation was observed to be more sensitive to R_{Mg} change than to R_{Na} change. In terms of desalination efficiency, while Na rejection variation had negligible effect on either the system water recovery or the system SECₙₑₜ because it had no significant impact on the membrane water recovery nor the pumping demand, Mg rejection was shown to slightly reduce the system water recovery and incur higher SECₙₑₜ (+0.10% per 1.0% R_{Mg} increase). This was because higher Mg rejection led to higher osmotic pressure in the later retentate streams and hindered the permeate volume production.

According to embodiments of the present disclosure, the system 100 is configured with a membrane selected for NF module permeability. To enhance the Mg—Na selectivity in Br1 of 2DiaNF-RO, the sensitivity analysis shows that improving NF module permeability is most preferred, followed by reducing Na rejection and increasing Mg rejection. Mg recovery in Br1 was only sensitive to higher Mg rejection, while net SEC was not very sensitive to the changes in NF membrane properties.

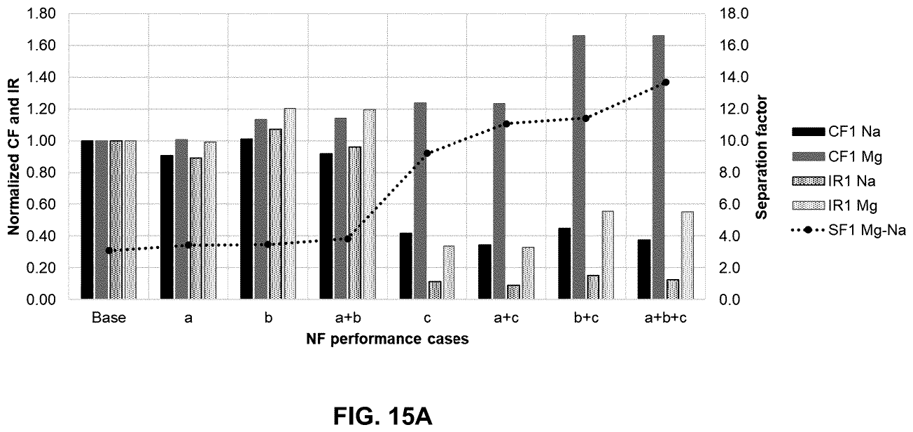

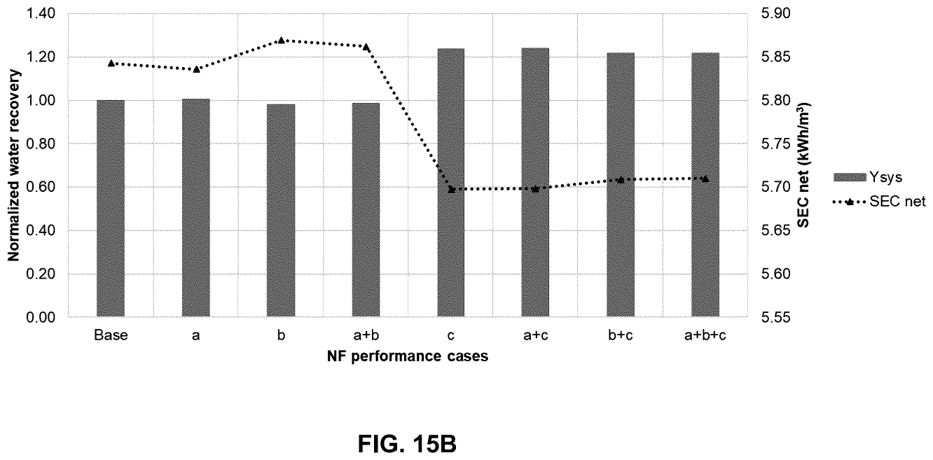

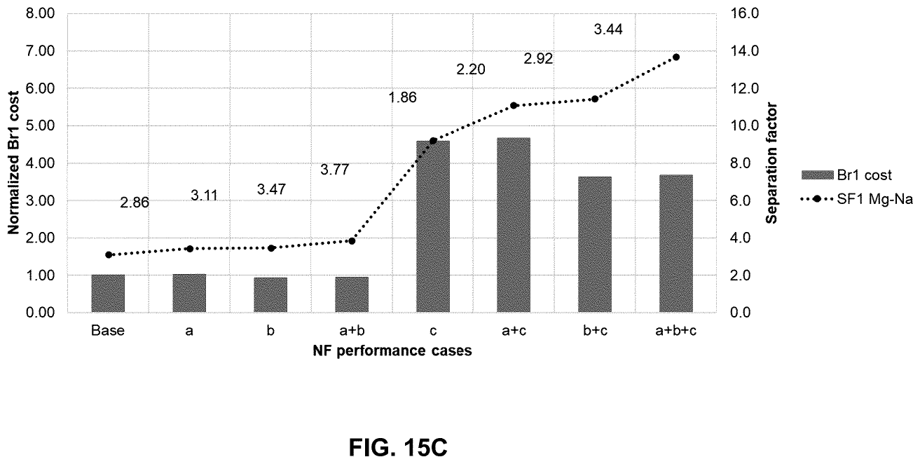

With the improved NF, FIG. 15A shows that there was more Mg—Na fractionation in Brine 1 of the 2DiaNF-RO owing to the better Na dilution and Mg concentration in all cases. SF1_{Mg—Na} was enhanced most drastically from 3.84 in case ‘a+b’ to 9.21 in case ‘c’, showing that enhancing NF permeability individually was much more impactful than improving both Na and Mg rejections. After case ‘c’, SF1_{Mg—Na} continued to rise steadily to 11.09 in case ‘a+c’, where Na dilution effect was dominant, and to 11.44 in case ‘b+c’, where Mg concentration effect became significant. SF1_{Mg—Na} finally reached the maximum value of 13.7 in case ‘a+b+c’, where all 3 NF improvements were combined.

This also allowed the Base case to achieve the desirable SF1_{Mg-Na}>8, as shown in FIG. 15A. FIG. 15A also illustrates the inverse relationship between IR1_{Mg} and SF1_{Mg-Na}. IR1_{Mg} was observed to increase the most when Mg rejection was improved without changing the NF permeability (i.e., case ‘b’ and case ‘a+b’), because more Mg ion was retained in the Br1 stream. However, when NF permeability became higher (i.e., case ‘c’), it enhanced the “wash out” effect of Mg ions to the permeate side and reduced IR1_{Mg} significantly, despite the higher SF1_{Mg-Na}.

In FIG. 15B, higher system water recovery and lower net SEC were observed most clearly when higher NF permeability was applied because it directly improved the permeate volume production. However, when higher Mg rejection was included (i.e., case ‘b’), the Y_{sys} and SECₙₑₜ became slightly worsened because the high Mg rejection could increase the osmotic pressure of the subsequent retentate streams and reduce the permeate flux. Nonetheless, if the NF water permeability was improved concurrently, the results would still be better than the Base. All in all, from the Base case to case ‘a+b+c’, the combined improved NF increased the system water recovery from 21.9% to 26.7%, which reduced the SECₙₑₜ by 2.78% from 5.95 to 5.78 kWh/m³.

FIG. 15C shows that in case ‘a’, case ‘b’, and case ‘a+b’, there was a slight reduction in the Br1 cost with limited SF1_{Mg—Na} improvement. Though it led to large SF:cost ratios, the SF1_{Mg—Na} was still lower than the desired value of 8.0. When NF permeability became higher in case c, Br1 cost increased by 4.6 times from the Base case to accommodate the significant SF1_{Mg—Na} increase from 3.1 to 9.2, but the cost utilization ratio was worsened to 1.86. This was because with better permeability, the system required a higher treatment capacity, e.g., higher capital expenditure (CAPEX) and higher pumping demand, e.g., higher operating expenses (OPEX). Combined with low Na rejection in case ‘a+c’, the cost increased further by 1.6% from case ‘c’, increasing SF1_{Mg—Na} from 9.2 to 11.1, which slightly improved the SF:Cost ratio to 2.20.

Coupled with high Mg rejection in case ‘b+c’, SF1_{Mg—Na} increased from 9.2 to 11.4 while the cost was reduced by 21.0% from case ‘c’, resulting in a better SF:Cost of 2.92. This was because high Mg rejection reduced the membrane requirement and SECₙₑₜ, which lowered the CAPEX and OPEX, respectively. Under simultaneous NF improvements in the case ‘a+b+c’, the highest SF1_{Mg—Na} of 13.7 was achieved at a 19.8% lower cost than in case ‘c’, resulting in a much improved SF:Cost of 3.44. This also shows that enhanced NF performance could potentially utilize the additional cost for ion fractionation more efficiently than using more NF stages.

nDiaNF-2RO

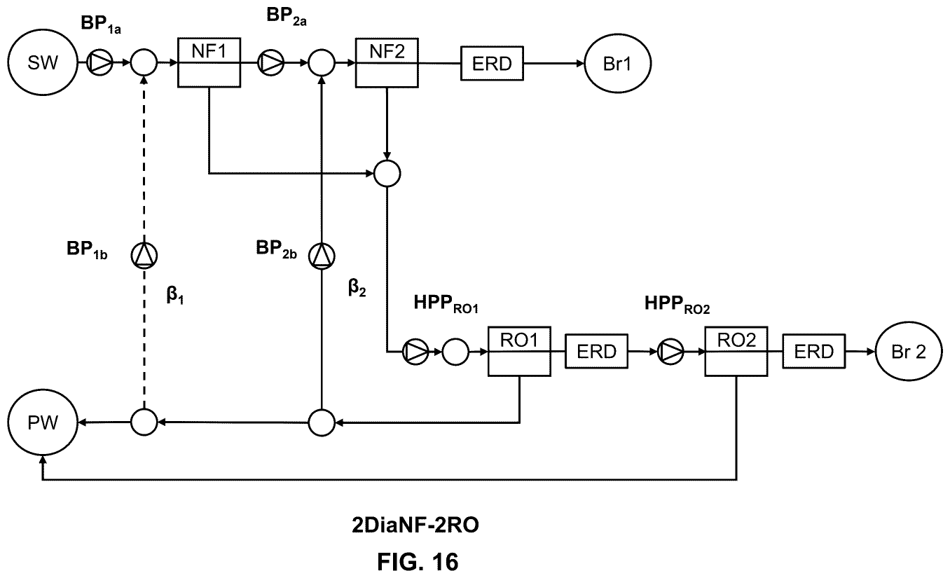

FIG. 16 is a schematic diagram of a 2DiaNF-2RO configuration of the system according to embodiments of the present disclosure.

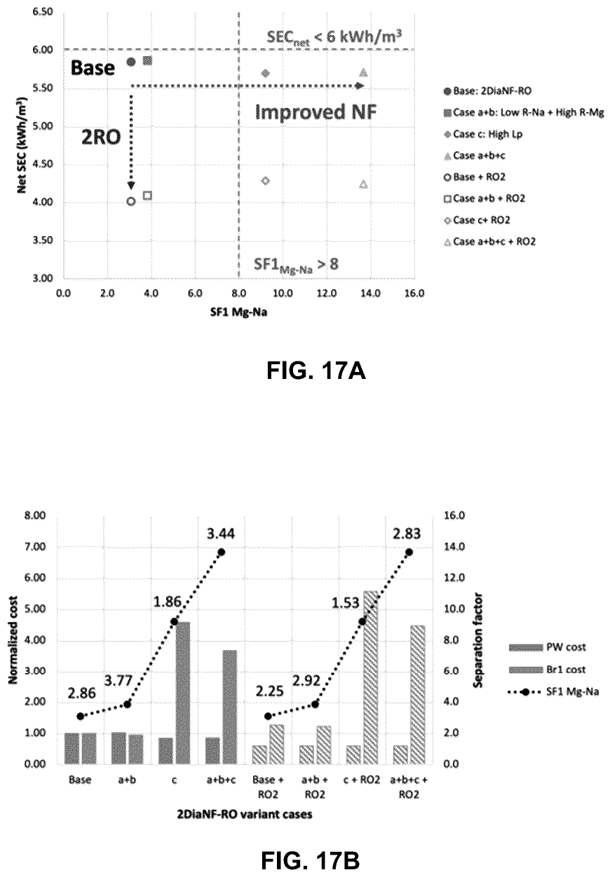

FIG. 17A shows how the 2DiaNF-2RO significantly reduced the SECₙₑₜ of 2DiaNF-RO in different cases. For instance, in the base case, the SECₙₑₜ decreased by 31.3% from 5.84 kWh/m³ in 2DiaNF-RO to 4.01 kWh/m³ in 2DiaNF-2RO. This was because the effects of higher product water volume outweighed the effects of additional pumping demand from the RO2 stage.

Adding β₀₂ to a 2DiaNF-RO with higher NF performance did not reduce SEC as greatly as in the base case. As the system water recovery was standardized at 42.5%, the water production advantage from higher NF permeability was compromised. Instead, the effect of higher pumping demand from higher flow became more significant, leading to the dampening of SEC reduction.

One possible drawback of adding the 2^{nd} RO stage was the potential higher cost incurred. From FIG. 17B, the PW cost of the 2DiaNF-2RO was shown to be reduced by 41.0% in base case and by 30.5% in case ‘a+b+c’. Most substantial PW cost reduction was observed in the cases without NF permeability improvement due to their largest increment of PW volume to meet the required Y_{sys}.

The viability of implementing the proposed system was considered from the cost. It was estimated that additional CAPEX (capital expenditure) and OPEX (operating expenditure) from the β₀₂ stage increased the Br1 cost by 26.9% in Base case and by 21.6% in case ‘a+b+c’. This was because with case ‘c’ involved, the recovery and pressure required of β₀₂ to reach the standardized Y_{sys}=42.5% were lower (Table 8), leading to a lower increase in OPEX. Nonetheless, the SF:Cost ratios for 2RO cases were still lower than those of 1RO cases because the SF1_{Mg—Na} was not improved with these changes. Overall, the results demonstrate that incorporating the 2^{nd} RO stage could be beneficial in SEC performance and PW cost.

TABLE 8
RO2 inputs for the selected cases of 2DiaNF-2RO to
satisfy the 42.5% overall system water recovery.

| Cases | Y_{RO2} | P_{RO2} (bar) | Ysys |
|---|---|---|---|
| Base | 38.47% | 65 | 42.50% |
| c | 23.25% | 55 | 42.50% |
| a + b | 39.66% | 70 | 42.50% |
| a + b + c | 24.29% | 55 | 42.50% |

### Other Benefits

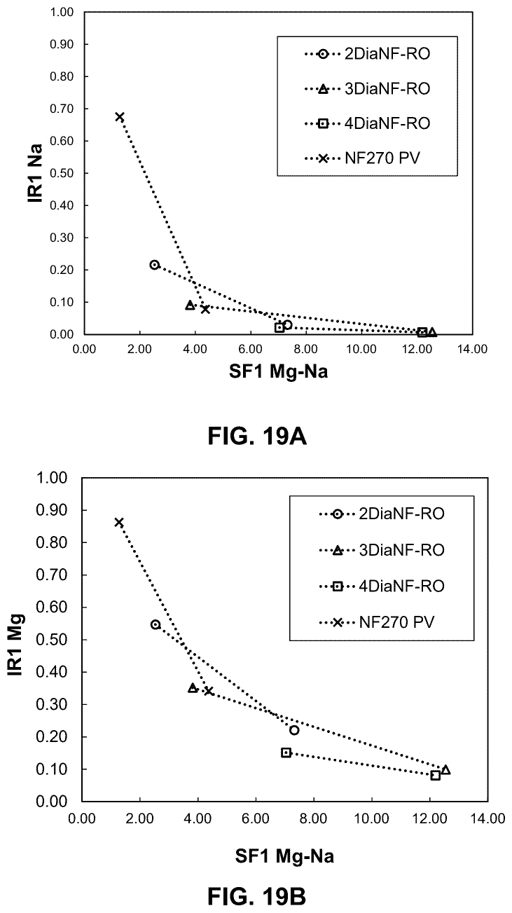

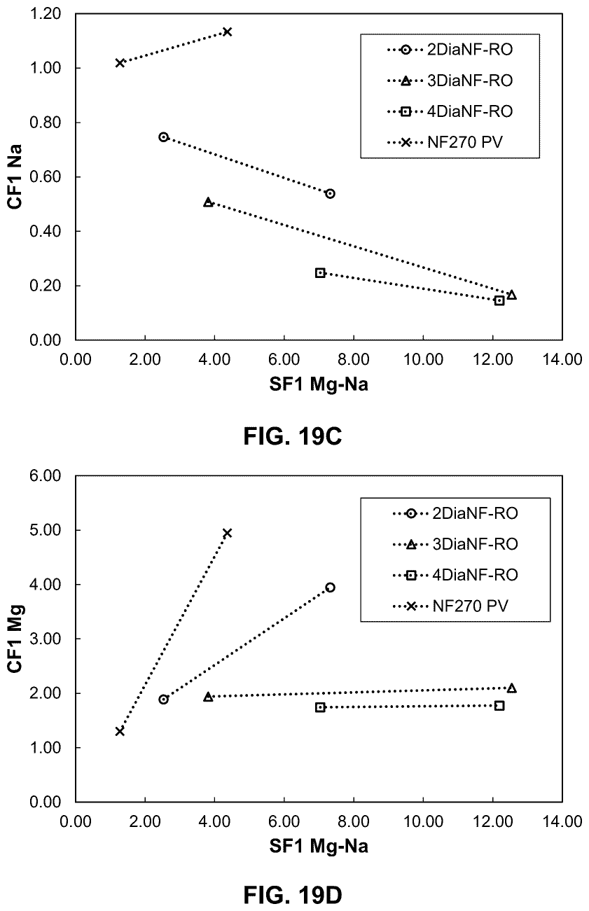

To further illustrate the advantages of the nDiaNF-RO process and system in ion fractionation, the nDiaNF-RO was compared to a single-pass NF270 PV simulation, where both were subjected to a same seawater feed at 35 g/L. Referring to FIG. 19A and FIG. 19B, applying diafiltration shifted the ion recovery trend rightward and downward, indicating an improvement of selectivity at the expense of lower ion recovery. In this case, the SF1_{Mg—Na} was increased by 3-12 times, from 1.28-4.37 range in NF270 PV to 7.04-12.19 range in 4DiaNF-RO.

In NF270 PV, the SF1 was increased by both Na and Mg concentration, while in nDiaNF-RO, it was improved by Na dilution and Mg concentration (FIG. 19C and FIG. 19D). The latter dilution approach in nDiaNF-RO was more favorable because it allowed the process to treat higher TDS feed (e.g., RO brine) and facilitated the subsequent ion recovery process better (e.g., evaporation, crystallization). DiaNF was experimentally verified at pilot scale for seawater remineralization, which implies that a similar benefit could be replicated for ion fractionation and recovery.

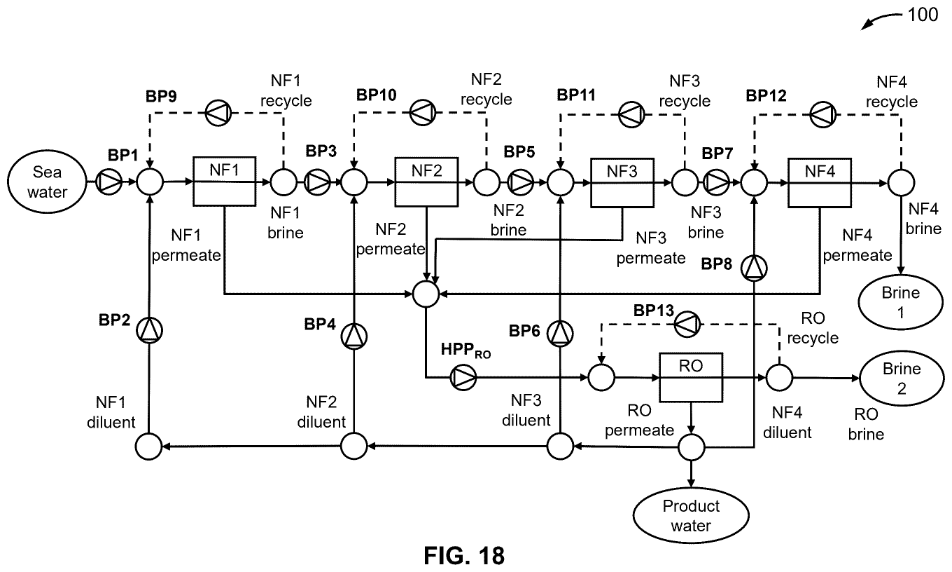

The representative optimal 4DiaNF-RO of FIG. 18 was compared with other conventional pressure-driven membrane processes that concentrated and fractionated Mg—Na in seawater in Table 9. In terms of ion fractionation application, though the 4DiaNF-RO did not concentrate the brine as much as a conventional dual brine concentrator, the 4DiaNF-RO configuration of the present system achieved 3 times better SF1_{Mg—Na} at 17.1% lower SECₙₑₜ. The energy-efficient advantage of 4DiaNF-RO is further evident from the lower SEC achievable with the 4 nDiaNF-RO system. For example, the SEC of 4 nDiaNF-RO system compares favorably over a conventional nNF-RO process (30.7% lower) and a conventional RO-nNF process (51.6% lower) respectively.

Without being limited by theory, such benefits could be attributed to the diafiltration step in NF stages of nDiaNF-RO, which not only lowered the RO feed concentration to reduce the SECₙₑₜ, but also enhanced Na⁺ dilution for better Mg—Na fractionation. The selectivity enhancement achievable with the present system can be seen when compared against each of other conventional processes, such as a conventional nDiaNF process, a conventional counter-current 2NF-DiaNF process, and a conventional cation ion exchange (CIX)—NF-DiaNF.

The proposed system 100 is unique in configuration and achievable results such that a direct comparison with conventional processes is not possible. For example, the conventional processes were all for remineralization of desalinated water application and not related to obtaining brine outputs that can serve further industrial use. For the 2NF-DiaNF and CIX—NF-DiaNF that had superior SF1_{Mg-Na}, it is important to note that they were both in batch mode, so the SECₙₑₜ was not available. This also highlights another unique feature of nDiaNF-RO, which was the integration of RO stage to the DiaNF process in a continuous operation mode to both self-provide the diluent and desalinate seawater.

Overall, the nDiaNF-RO was shown to have comparable if not improved performance in terms of both Mg—Na fractionation and SECₙₑₜ requirement, by leveraging on the dilution enhancement of diafiltration, the Mg—Na fractionation of NF, and the desalination capability of RO.

TABLE 9
Comparison between the representative optimal nDiaNF-RO (n = 4) and other state- of-
the-art pressure-driven membrane processes that concentrate and fractionate Mg—Na in seawater.

| | Feedₐ | Brine_{b} | | | | SECₙₑₜ | |
|---|---|---|---|---|---|---|---|
| Process | (g/L) | (g/L) | CF1_{Na} | CF1_{Mg} | SF1_{Mg—Na} | (kWh/m³) | Application |
| nDiaNF-RO | 35.3 | 34.1 | 0.15 | 1.77 | 12.19 | 5.72 | Ion fractionation |
| NF-RO-MBC | 45.0 | 90.5 | 1.32 | 5.39 | 4.09 | 6.90 | Ion fractionation |
| nNF-RO | 33.6 | 40.0 | — | 1.19 | — | 8.25 | LDAC_{c} |
| RO-nNF | 33.6 | 46.8 | — | 1.39 | — | 11.82 | ZLD |
| nDiaNF | 41.1 | 31.6 | — | 3.40 | >10 | — | Remineralization |
| 2NF-DiaNF | 37.5 | 13.8 | 0.03 | 3.38 | 124.8 | — | Remineralization |
| (countercurrent) | | | | | | | |
| CIX-NFDiaNF | 38.3 | 7.1 | 0.06 | 1.71 | 28.2 | — | Remineralization |

### NF Membranes

The NF270 membrane's simulation was derived from the empirically fitted S—K model parameters. It was observed that the low Mg²⁺ recovery of nDiaNF-RO in Br1 was due to the low Mg²⁺ rejection of NF270. This value is consistent with the conventional case, where Mg rejection became lower under seawater conditions. This could be due to the complex ion-ion and ion-membrane interactions in the high salinity multi-ion feed solutions.

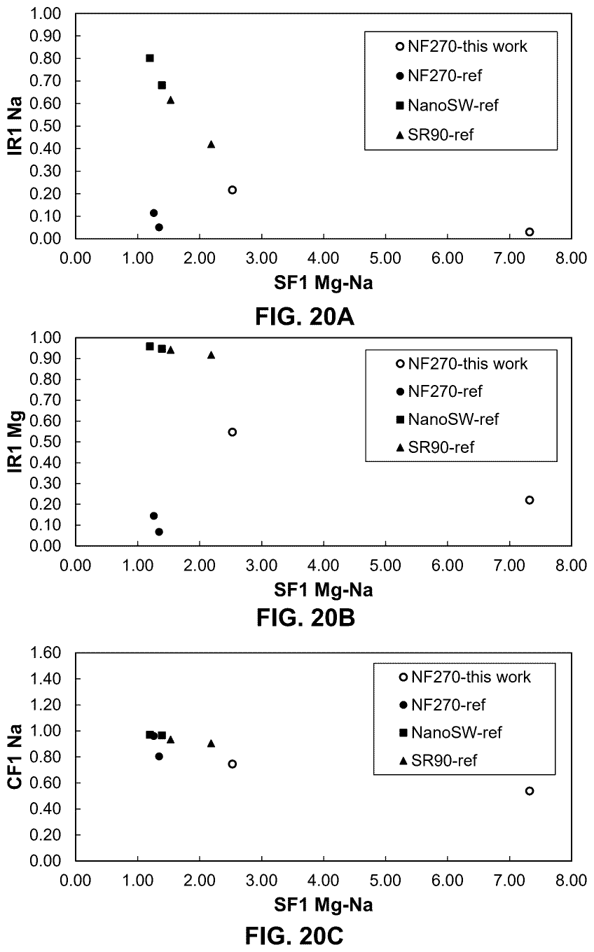

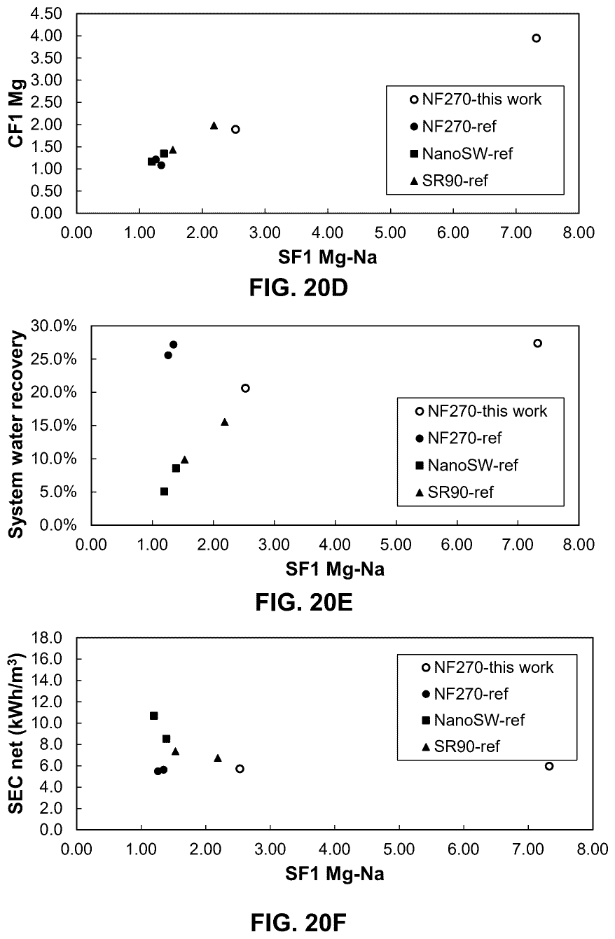

Assuming the S—K parameters were constant with respect to TDS concentration, the relevant commercial NF membranes were also compared with NF270 from the experiments. Table 10 shows the corresponding S—K parameters of the NF membranes at 30.4 g/L TDS. SR90 from Dow FilmTec and NanoSW from Nitto Hydranautics were selected due to their high Mg—Na rejection, based on the σ_{GMg}-σ_{Na} ratio. Na⁺ and Mg²⁺ rejection is based on 1 NF PV with 8 elements at 12 bar and 35 g/L TDS. These NF were then applied in the 2DiaNF-RO at its lowest and highest maximum SF1_{Mg—Na} conditions, where the effects of are shown in FIG. 20A to FIG. 20F.

TABLE 10
Constant S-K parameters of commercial NF membranes at
30.4 g/L TDS. The Na and Mg rejections are at 12 bar
and 35 g/L TDS for 1 pressure vessel with 8 elements.

| | Lₚ | | Pₛ | |
|---|---|---|---|---|
| | (L/m² · h · bar) | σ | (L/m² · h) | Rejection |
| NF270 | 6.1 | Na: 0.08 | Na: 31.0 | Na: 3.4% |
| | | Mg: 0.65 | Mg: 5.79 | Mg: 56.2% |
| NF270-ref | 4.95 | Na: 0.19 | Na: 5.48 | Na: 13.0% |
| | | Mg: 0.45 | Mg: 22.2 | Mg: 21.6% |
| NanoSW-ref | 1.9 | Na: 0.29 | Na: 15.98 | Na: 12.3% |
| | | Mg: 0.93 | Mg: 1.25 | Mg: 84.9% |
| SR90-ref | 3.3 | Na: 0.25 | Na: 26.33 | Na: 10.6% |
| | | Mg: 0.92 | Mg: 1.18 | Mg: 89.3% |

It was observed in FIG. 20A that if the S—K remained constant instead of varying with TDS concentration, the range of SF1_{Mg—Na} became narrower. It also limited the possible range of NF pressure applied, which explained why the NF270-ref performed worse than the empirical NF270 in the 2DiaNF-RO. This study highlighted the relevance of fitting the NF model parameters to TDS concentration.

For NanoSW-ref and SR90-ref that had higher Mg²⁺ rejection than NF270 and NF270-ref, there was a significant improvement of Mg²⁺ recovery in Br1 (FIG. 20B). Among the referenced NF membranes, SR90-ref emerged as the most suitable to achieve high IR1_{Mg} and SF1_{Mg—Na} simultaneously because of its highest Mg²⁺ rejection. However, due to the trade-off in water permeability, NanoSW-ref and SR90-ref may not produce sufficient flow for Na⁺ dilution (FIG. 20C), Mg²⁺ concentration (FIG. 200), and water production (FIG. 20E). As a result, they may obtain a lower SF1_{Mg—Na} at a higher SECₙₑₜ than NF270 (FIG. 20F). Here, NanoSW was observed to be the least competitive due to its lowest water permeability, despite having decently high Mg²⁺ rejection as shown in Table 11.

According to various embodiments of the present disclosure, the 2DiaNF-RO configuration is preferably configured to simultaneously achieve high Mg²⁺ recovery and high Mg—Na fractionation at a low SEC, using a NF membrane selected for its membrane properties in terms of a high water permeability and a high (multivalent) ion rejection rate. Given a choice, the membrane with the higher water permeability is preferably selected over the membrane with the higher (multivalent) ion rejection. For example, in this example, the membrane with a high-water permeability (e.g., NF270) may be selected over the membrane with a high Mg²⁺ rejection (e.g., SR90-ref).

### Comparison of Pre-Treatment and Post-Treatment of Ion Fractionation

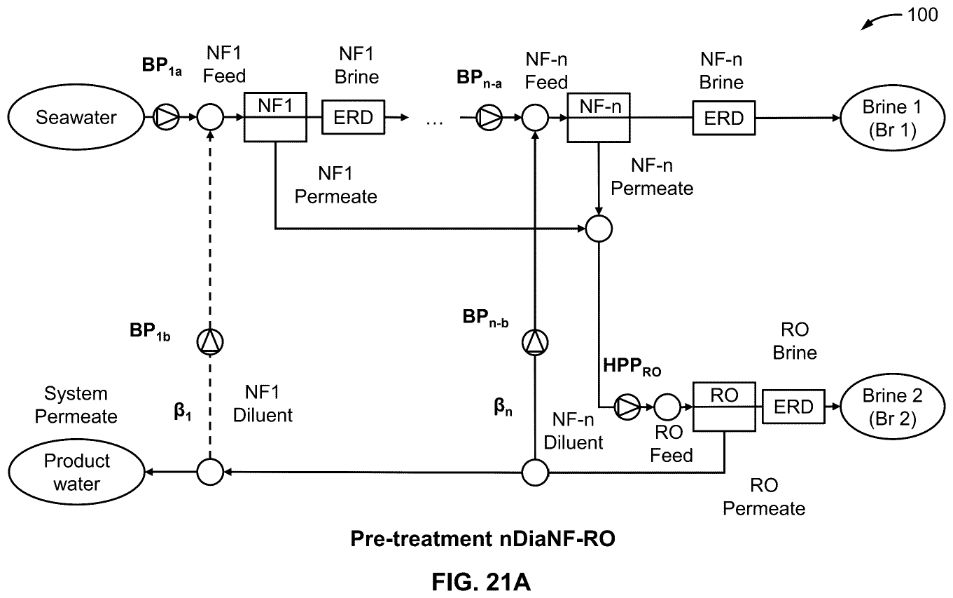

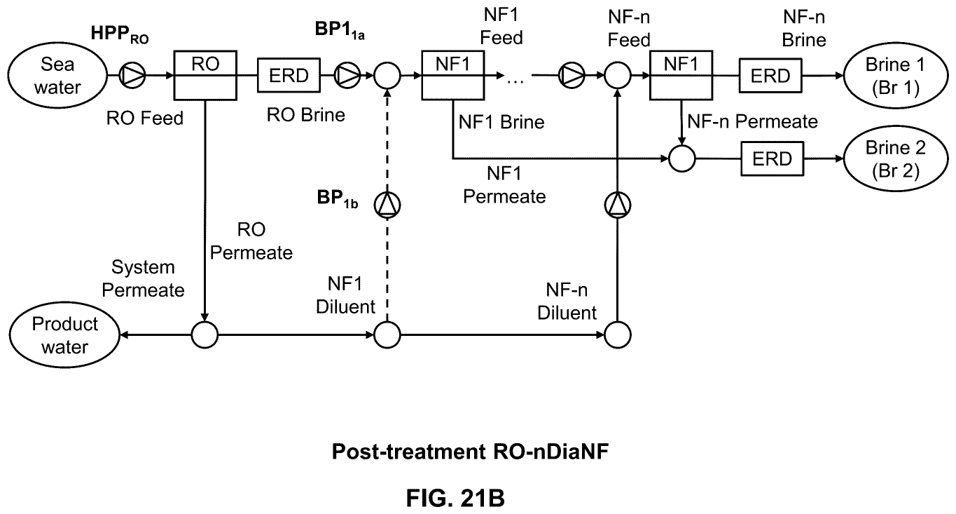

FIG. 21B shows the RO-nDiaNF, which is configured with ion fractionation at post-treatment stage. It includes a single stage RO that supplies product water and diluent from seawater, and n stages of diafiltration-NF that concentrate and fractionate ions from SWRO brine. HPP, BP, and ERD are also employed in RO-nDiaNF. Overall, at the system level, the RO-nDiaNF produces three streams: a PW stream from RO permeate, a Br1 stream with divalent ion dominance, and a Br2 stream with monovalent ion dominance, similar to nDiaNF-RO as shown in FIG. 21A.

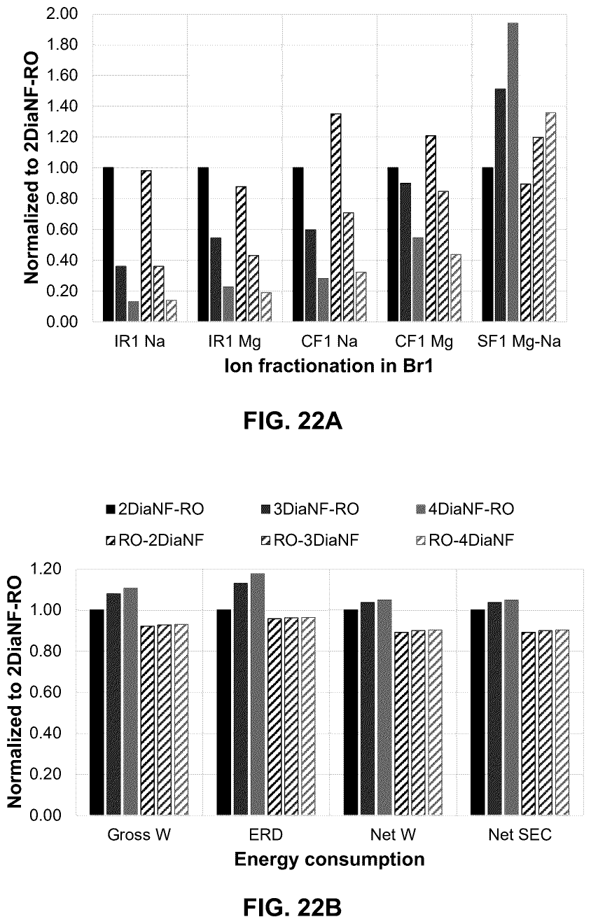

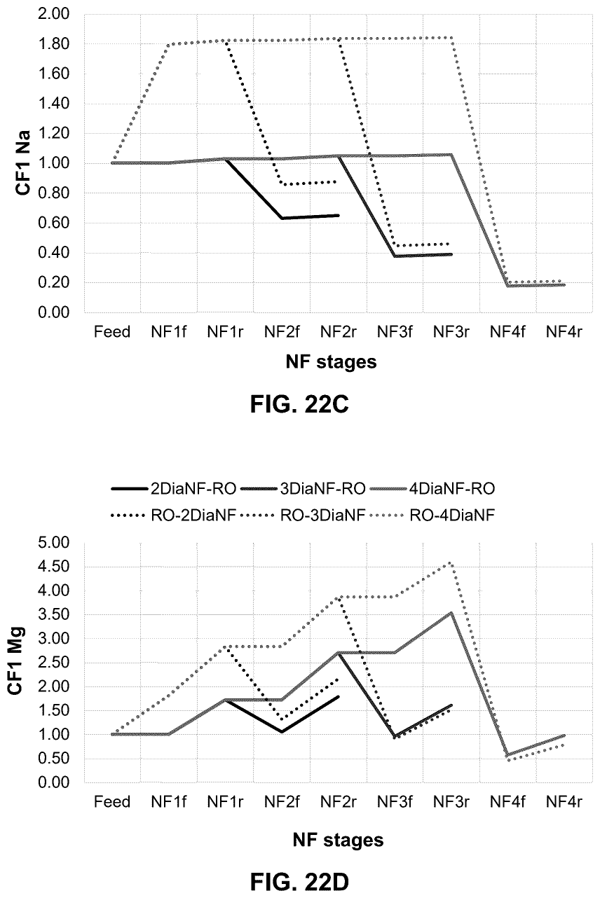

FIG. 22A to FIG. 22D compare the performance of nDiaNF-RO with RO-nDiaNF. FIG. 22A shows that the nDiaNF-RO had a higher SF1_{Mg—Na} than RO-nDiaNF at all n. One reason was from the higher Na dilution in nDiaNF-RO due to its lower initial Na concentration in the NF stages (FIG. 22C). Another reason was from the higher Mg concentration in nDiaNF-RO, especially at large n, because Mg was diluted more significantly in the last NF stage in RO-nDiaNF, despite its higher initial concentration in the NF streams (FIG. 22D).

This also explained the wider SF gap between the two approaches as n increased. Moreover, with the higher dilution factor in the NF stages, RO-nDiaNF also experienced lower Mg recovery in Br1, because more Mg was “washed out” to the NF permeate. More stages often led to a much better SF1_{Mg—Na} in both schemes, which implied that substantial Na dilution controlled the Mg—Na selectivity in Br1.

It would seem that the nDiaNF-RO processes had higher system net SEC because it required higher net work done rate at the same system water recovery (FIG. 22B). This was due to the higher feed flow rates in nDiaNF-RO, which required more gross pumping energy, especially at the high-pressure RO stage where it received large flow from the NF permeate streams.

At large n, the net SEC became slightly higher for both processes due to the additional booster pumps required. The increasing effect may not appear very significant because of the low NF pressure used and the low feed flow rates in these stages. In terms of ion fractionation and desalination, nDiaNF-RO demonstrated better Mg recovery and Mg—Na selectivity in Br1, at the expense of higher net SEC.

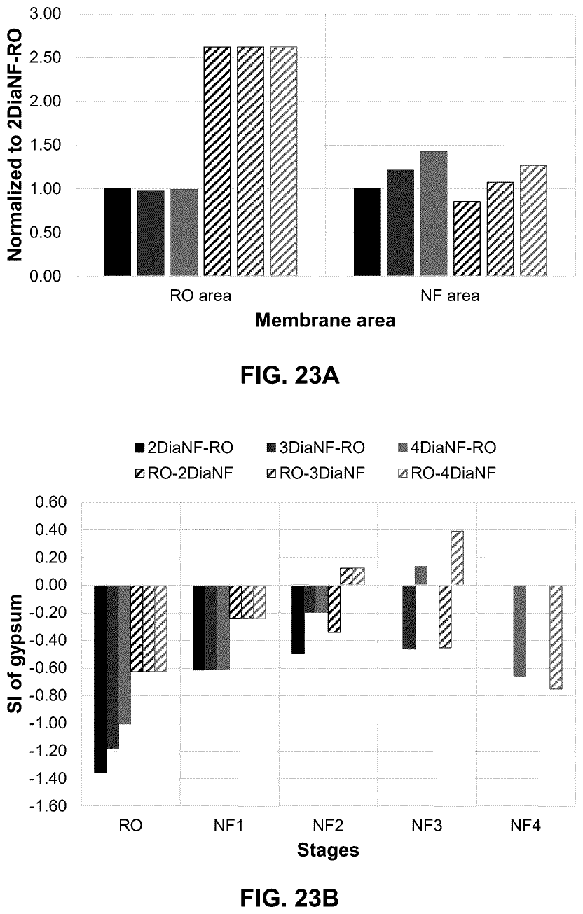

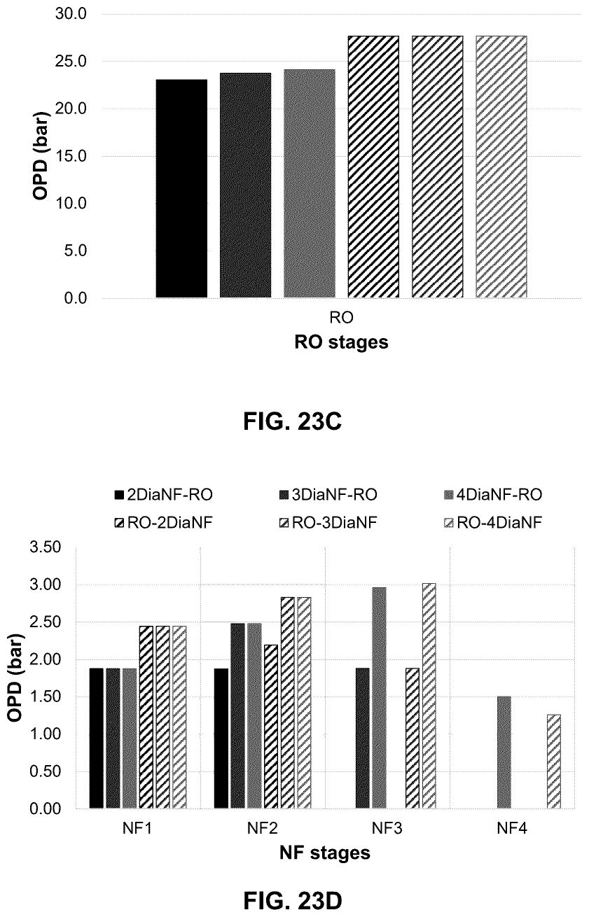

FIG. 23A and FIG. 23B compare the other operating indicatprs for the systems of FIG. 21A and FIG. 21B. FIG. 23A shows that nDiaNF-RO required less than half of the RO area in RO-nDiaNF to produce the same amount of product water because the former obtained a higher RO permeate flux from the less concentrated RO feed than the latter. In this case, increasing the number of stages did not significantly affect the RO area required because for RO-nDiaNF, the feed flow of RO was unchanged while for nDiaNF-RO, the RO recovery was reduced at high n to maintain the equal product water flow from the increased RO feed flow.

It would seem that nDiaNF-RO required more NF area than RO-nDiaNF to achieve the same stage recovery because of the much higher flow rates in the pre-treatment streams. The higher NF permeate flux in nDiaNF-RO, which was due to the lower osmotic pressure, mitigated the NF area requirement difference between the pre-treatment and post-treatment processes.

In terms of scaling risk, FIG. 23B, Table 11A and Table 11B show that SI<0 for most nDiaNF-RO and RO-nDiaNF conditions studied, except at the penultimate NF stages at large n, as illustrated by the positive SI=0.13 in NF3 of 4DiaNF-RO and a higher SI=0.39 in NF3 of RO-4DiaNF. This implied that RO-nDiaNF was more prone to gypsum scaling due to its more concentrated sulfate in the streams.

For the RO stages, there was no oversaturation risk in both treatment schemes at the current operating conditions due to their negative SI values. Nonetheless, membrane fouling by scaling could be considered marginal in both cases because the SI values were within the allowable threshold (i.e., SI<log (2.3)=0.36), which indicated that no additional chemical are required for cleaning and fouling control.

Using gypsum (CaSO₄·2H₂O) as the potential scalant, the scaling risks on NF and RO surface are calculated via the saturation index (SI). Firstly, the ion concentrations at the membrane surface were determined from the film theory of the concentration polarization (CP) effect. Then, the SI was computed by the Visual MINTEQ software (version 3.1) based on equation (38). If SI>0, there would be a probable risk of scaling formation on the membrane surface.

$$S I = log ( \frac{Ion activity product}{Solubility product} ) \qquad ( 38 )$$

TABLE 11A
SI of gypsum of the nDiaNF-RO and RO-nDiaNF

| | SI of gypsum | | | | |
|---|---|---|---|---|---|
| Designs | NF1 | NF2 | NF3 | NF4 | RO |
| 2DiaNF-RO | −0.614 | −0.496 | −1.355 | | |
| 3DiaNF-RO | −0.614 | −0.197 | −0.463 | −1.183 | |
| 4DiaNF-RO | −0.614 | −0.197 | 0.135 | −0.66 | −1.006 |
| RO-2DiaNF | −0.242 | −0.341 | −0.628 | | |
| RO-3DiaNF | −0.242 | 0.123 | −0.455 | −0.628 | |
| RO-4DiaNF | −0.242 | 0.123 | 0.39 | −0.753 | −0.628 |

TABLE 11B
Comparison of SI of gypsum of the 2DiaNF-RO with
the NF performance cases and 2nd RO integration.

SI of gypsum

| Cases | NF1 | NF2 | RO1 | RO2 |
|---|---|---|---|---|
| Base | −0.58 | −0.392 | −1.501 | −1.13 |
| a | −0.578 | −0.386 | −1.5 | −1.129 |
| b | −0.582 | −0.402 | −1.496 | −1.118 |
| c | −0.531 | −0.407 | −1.204 | −0.86 |
| a + b | −0.58 | −0.397 | −1.497 | −1.118 |
| a + c | −0.531 | −0.406 | −1.201 | −0.856 |
| b + c | −0.533 | −0.416 | −1.225 | −0.878 |
| a + b + c | −0.532 | −0.415 | −1.222 | −0.875 |

FIG. 23C and FIG. 23D show the OPD in RO and NF stages at steady state, respectively. In general, nDiaNF-RO had lower OPD than RO-nDiaNF because there was more dilution effect at the RO feed and less concentration effect at the NF feed in the pre-treatment design, which reduced the TDS feed concentration at those points. The lower OPD in nDiaNF-RO also implied that the pre-treatment scheme could operate at a higher pressure and recovery and increase the SF when necessary.

FIG. 23D shows that, in both nDiaNF-RO and RO-nDiaNF, at the same pressure and recovery, the OPD of the last dilution NF stage was always smaller than the OPDs of the previous concentration NF stages. The effect was more prominent at large n when the OPDs of the NF concentration stages were higher. This indicates that if there was sufficient flow, the last NF stage may be prioritized to operate at a higher pressure and recover for more fractionation and desalination. Overall, in terms of membrane utilization, nDiaNF-RO required lower RO area, lower scaling risk, and lower osmotic pressure than RO-nDiaNF.

### Viability of Practical Implementation

Both 2DiaNF-RO and RO-2DiaNF had similar cost distributions, with the highest contributions from electric power (24-26%), followed by infrastructure (13%) and membrane replacement (9-10%).

The nDiaNF-RO had higher annualized CAPEX and OPEX per cubic meter Br1 than RO-nDiaNF at same n and Y_{sys}.

For CAPEX, this was because the membrane stages from nDiaNF-RO generally treated higher flow, so it required higher treatment capacity, leading to higher costs in pumps, membranes, piping, and infrastructure. For OPEX, the main contributing was the high electric power cost, which was due to the higher net SEC in nDiaNF-RO. Large membrane stages in nDiaNF-RO also led to higher membrane replacement and maintenance costs. This resulted a higher Br1 cost in nDiaNF-RO than in RO-nDiaNF. This cost could be explained by the higher separation factor in nDiaNF-RO. The SF:Cost value of 2DiaNF-RO (2.22) was higher than that of the RO-2DiaNF (2.13), indicating the more efficient cost utilization in 2DiaNF-RO for Mg—Na fractionation. At higher n, the SF:Cost of nDiaNF-RO became lower than that of RO-nDiaNF, which implied a declining cost advantage when more NF stages were added.

In other words, while it would appear that the additional cost in 3DiaNF-RO and 4DiaNF-RO was not as efficiently used to fractionate ions, it bear noting that these results were obtained at 22.5% recovery. At this recovery level, the SF1_{Mg—Na} of RO-nDiaNF was near its upper limits, while nDiaNF-RO could still further increase the SF1_{Mg-Na} values. Overall, the relatively higher cost in nDiaNF-RO could be attributed to its higher ion fractionation activity, where lower n was preferred for a better cost utilization ratio.

In this comparative analysis, nDiaNF-RO was shown to be more beneficial than RO-nDiaNF in terms of Mg recovery and Mg—Na selectivity in Br1, membrane area saving, gypsum scaling potential, and OPD. The main differentiating features of the pre-treatment were the lower feed TDS concentration, which facilitated better ion fractionation, and the higher feed flow rates, which demanded more pumping energy and treatment capacity. Despite incurring higher SECₙₑₜ, nDiaNF-RO could still operate at a higher pressure and recovery to narrow the gap, while RO-nDiaNF was already near the upper limits. At low n, nDiaNF-RO also had a better ratio of cost conversion to SF improvement.

Overall, the study shows that initiating the ion fractionation earlier with diafiltration results in various performance benefits in the brine management process, which further demonstrates the viability of the nDiaNF-RO configuration.

In an earlier study, the nDiaNF-RO system compared favorably against the RO-nDiaNF system as shown below.

TABLE 12
DiaNF-RO vs. RO-DiaNF at n = 4 stages

| Output aspects | Output results | 4DiaNF-RO | RO-4DiaNF |
|---|---|---|---|
| Standardized | System water recovery | 22.50% | 22.50% |
| Performance | CF Na in NF brine 1 | 0.18 | 0.21 |
| | CF Mg in NF brine 1 | 0.97 | 0.78 |
| | SF Mg-Na in NF brine 1 | 5.33 | 3.73 |
| | CF Na in RO brine 2 | 1.44 | 1.42 |
| | CF Mg in RO brine 2 | 1.33 | 1.35 |
| | SF Na-Mg in RO brine 2 | 1.08 | 1.05 |
| | Net SEC (kWh/m³) | 5.1 | 4.39 |
| Operation | RO area required (m²) | 89 | 236 |
| | RO CP value | 1.08 | 1.09 |
| | RO OPD (bar) | 24.1 | 27.6 |
| Economic | Electricity cost (′000 | 49.1 | 42.3 |
| | USD/year) | | |
| | RO cost (′000 USD/year) | 20.1 | 53.3 |
| | NF cost (′000 USD/year) | 35.8 | 32.2 |
| | Total cost (′000 USD/year) | 105.1 | 127.8 |

As shown in Table 12, compared to RO-nDiaNF, the nDiaNF-RO has better Mg—Na ion separation factor (SE) in both NE and RO brines; higher Na dilution in NE brine; lower RO area requirement; larger potential to operate at higher pressure and recovery due to lower osmotic pressure difference at membrane stages; less total operating cost especially with more stages due to more RO area saving. Overall, the pre-treatment nDiaNF-RO achieves better results in performance and in operation (as well as in economic terms) than the conventional post-treatment RO-nDiaNF.

According to various embodiments of the present disclosure, a system includes one or more nanofiltration (NF) stages configured to perform a diafiltration process and one or more reverse osmosis (RO) stages. One or more nanofiltration (NF) stages are configured to perform a diafiltration process. Each of the one or more NF stages is configured to process a NF feed and produce a NF permeate and a NF retentate. The one or more NF stages cooperatively produce a first brine output of the system. Each of the one or more RO stages is configured to process an RO feed and produce an RO permeate and an RO retentate. At least a part of the RO retentate forms a second brine output of the system. The RO feed to each of the one or more RO stages is exclusively formed from the one or more NF permeate from all of the one or more NF stages.

The system may include a NF diluent formed by a portion of the RO permeate, in which the NF diluent is provided to at least one of the one or more NF stages.

The one or more NF stages may include a plurality of the NF stages connected in a series, with the respective NF retentate of an upstream one of the plurality of the NF stages contributing to the respective NF feed of a downstream one of the plurality of the NF stages. The first brine output may be provided exclusively by a last of the plurality of the NF stages.

The NF diluent may be provided to at least the last of the plurality of the NF stages.

A first selected one or more of the plurality of the NF stages may be configured to operate without the NF diluent. A second selected one or more of the plurality of the NF stages may be configured to operate with the NF diluent, in which all of the first selected one or more of the plurality of the NF stages are upstream of all of the second selected one or more of the plurality of the NF stages.

A ratio of the NF diluent provided to any one of the plurality of the NF stages to the RO permeate may be in a range from 0.30 to 0.70.

The plurality of the NF stages may be formed by an upstream NF stage and a downstream NF stage, in which a ratio of the NF diluent provided to the downstream NF stage to the RO permeate is 0.5.

At least one of the one or more NF stages may be configured to recycle the respective NF retentate through the at least one of the one or more NF stages.

The one or more RO stages may be configured to recycle the RO retentate through the one or more RO stages.

The system may include a system input, in which the system input feeds exclusively into a first of the one or more NF stages, and in which the first brine output and the second brine output are formed from different ion fractionated streams of the system input.

The first brine output may be characterized by a higher content of multivalent ions in comparison to the second brine output.

The system input may be configured to deliver a supply of saline water to the first of the one or more NF stages, the saline water including the multivalent ions and monovalent ions, in which the RO permeate contributes to a desalinated water output of the system.

A composition of the first brine output may be configured as a source of the multivalent ions from which at least a portion of the multivalent ions are extractable.

The multivalent ions may be selected from the group consisting of magnesium ions, calcium ions, sulfate ions, carbonate ions, and a combination of any two or more thereof.

A composition of the second brine output may include a lower concentration of the multivalent ions in comparison with the first brine output.

A composition of the second brine output may be configured as a source of monovalent ions from which at least a portion of the monovalent ions is extractable.

The monovalent ions may be selected from the group consisting of sodium ions, lithium ions, chlorine ions, potassium ions, hydrogen carbonate ions, and a combination of any two or more thereof.

A composition of the first brine output may be configurable in an operation of the system, in which the composition of the first brine output is responsive to a change in any one or more of the following: (i) a ratio of the NF diluent provided to any one of the plurality of the NF stages to the RO permeate; (ii) a number of the one or more NF stages operating in the operation; (iii) an NF pressure of the NF feed; and (iv) a rate of flow of the NF feed.

Each of the one or more NF stages may include an NF membrane, in which a composition of the first brine output is dependent on one or more membrane properties of the NF membrane.

The one or more RO stages may include a first RO stage and a second RO stage, in which the one or more NF permeate is wholly provided to the first RO stage as the RO feed of the first RO stage, and in which the second brine output is formed exclusively from the RO retentate of the second RO stage, the RO retentate of the first RO stage being wholly provided to the second RO stage as the RO feed of the second RO stage.

All examples described herein, whether of apparatus, methods, materials, or products, are presented for the purpose of illustration and to aid understanding, and are not intended to be limiting or exhaustive. Modifications not involving inventive effort may be made by one of ordinary skill in the art without departing from the scope of the claimed invention.

1. A system comprising:
one or more nanofiltration (NF) stages configured to perform a diafiltration process, each of the one or more NF stages being configured to process a NF feed and produce a NF permeate and a NF retentate, the one or more NF stages cooperatively producing a first brine output of the system; and
one or more reverse osmosis (RO) stages, each of the one or more RO stages being configured to process an RO feed and produce an RO permeate and an RO retentate, at least a part of the RO retentate forming a second brine output of the system, wherein the RO feed to each of the one or more RO stages is exclusively formed from the one or more NF permeate from all of the one or more NF stages.

2. The system as recited in claim 1, comprising a NF diluent formed by a portion of the RO permeate, the NF diluent being provided to at least one of the one or more NF stages.

3. The system as recited in claim 2, the one or more NF stages being a plurality of the NF stages connected in a series, the respective NF retentate of an upstream one of the plurality of the NF stages contributing to the respective NF feed of a downstream one of the plurality of the NF stages, the first brine output being provided exclusively by a last of the plurality of the NF stages.

4. The system as recited in claim 3, wherein the NF diluent is provided to at least the last of the plurality of the NF stages.

5. The system as recited in claim 4, wherein a first selected one or more of the plurality of the NF stages are configured to operate without the NF diluent, and wherein a second selected one or more of the plurality of the NF stages are configured to operate with the NF diluent, all of the first selected one or more of the plurality of the NF stages being upstream of all of the second selected one or more of the plurality of the NF stages.

6. The system as recited in claim 3, wherein a ratio of the NF diluent provided to any one of the plurality of the NF stages to the RO permeate is in a range from 0.30 to 0.70.

7. The system as recited in claim 6, wherein the plurality of the NF stages is formed by an upstream NF stage and a downstream NF stage, and wherein a ratio of the NF diluent provided to the downstream NF stage to the RO permeate is 0.5.

8. The system as recited in claim 3, wherein at least one of the one or more NF stages is configured to recycle the respective NF retentate through the at least one of the one or more NF stages.

9. The system as recited in claim 3, wherein the one or more RO stages are configured to recycle the RO retentate through the one or more RO stages.

10. The system as recited in claim 1, comprising:
a system input, the system input feeding exclusively into a first of the one or more NF stages, wherein the first brine output and the second brine output are formed from different ion fractionated streams of the system input.

11. The system as recited in claim 3, wherein the first brine output is characterized by a higher content of multivalent ions in comparison to the second brine output.

12. The system as recited in claim 11, wherein the system input is configured to deliver a supply of saline water to the first of the one or more NF stages, the saline water including the multivalent ions and monovalent ions, and wherein the RO permeate contributes to a desalinated water output of the system.

13. The system as recited in claim 12, wherein a composition of the first brine output is configured as a source of the multivalent ions from which at least a portion of the multivalent ions are extractable.

14. The system as recited in claim 13, wherein the multivalent ions are selected from the group consisting of magnesium ions, calcium ions, sulfate ions, carbonate ions, and a combination of any two or more thereof.

15. The system as recited in claim 13, wherein a composition of the second brine output comprises a lower concentration of the multivalent ions in comparison with the first brine output.

16. The system as recited in claim 13, wherein a composition of the second brine output is configured as a source of monovalent ions from which at least a portion of the monovalent ions is extractable.

17. The system as recited in claim 16, wherein the monovalent ions are selected from the group consisting of sodium ions, lithium ions, chlorine ions, potassium ions, hydrogen carbonate ions, and a combination of any two or more thereof.

18. The system as recited in claim 3, wherein a composition of the first brine output is configurable in an operation of the system, the composition of the first brine output being responsive to a change in any one or more of the following: (i) a ratio of the NF diluent provided to any one of the plurality of the NF stages to the RO permeate; (ii) a number of the one or more NF stages operating in the operation; (iii) an NF pressure of the NF feed; and (iv) a rate of flow of the NF feed.

19. The system as recited in claim 3, wherein each of the one or more NF stages comprising an NF membrane, and wherein a composition of the first brine output is dependent on one or more membrane properties of the NF membrane.

20. The system as recited in claim 3, wherein the one or more RO stages comprises a first RO stage and a second RO stage, wherein the one or more NF permeate is wholly provided to the first RO stage as the RO feed of the first RO stage, and wherein the second brine output is formed exclusively from the RO retentate of the second RO stage, the RO retentate of the first RO stage being wholly provided to the second RO stage as the RO feed of the second RO stage.
